(19) United States
(12) Patent Application Publication
(10) Pub. No.: US 2024/0265349 A1
(43) Pub. Date: Aug. 8, 2024

(54) APPLICATION PROGRAMMING INTERFACES FOR ANALYZING COMBINATIONS OF APPLICANT AND EMPLOYMENT DATA

(71) Applicant: Degree, Inc., San Francisco, CA (US)

(72) Inventors: Benjamin Kaye, Vancouver (CA); Brian Brown, Richmond, VA (US); Sivanmani Varun, Walnut Creek, CA (US); Zoe Aviva Greene, San Francisco, CA (US)

(21) Appl. No.: 18/431,692

(22) Filed: Feb. 2, 2024

Related U.S. Application Data
(60) Provisional application No. 63/483,199, filed on Feb. 3, 2023.

(51) Int. Cl. G06Q 10/105; G06F 9/54; G06Q 10/0639

(52) U.S. Cl. CPC G06Q 10/105; G06F 9/54; G06Q 10/06398

(57) ABSTRACT

A method of analyzing employment-related data from a plurality of disparate systems is disclosed. The employment-related data is retrieved from the plurality of disparate systems. The plurality of disparate systems includes a human resource information system (HRIS) and an applicant tracking system (ATS). The data comprises applicant information and employee performance metrics. The retrieved data is transformed by standardizing and aggregating the data into a unified dataset based on a common semantic model that aligns definitions and formats across the disparate systems. The unified dataset is analyzed to identify trends, patterns, or correlations within the data using one or more analytical or machine learning algorithms. The unified dataset or corresponding analyses are updated in real-time through an application programming interface (API).

### CROSS REFERENCE TO RELATED APPLICATIONS

This application claims the benefit of U.S. Provisional Application No. 63/483,199, filed Feb. 3, 2023, which is incorporated by reference herein in its entirety.

### TECHNICAL FIELD

The present application relates generally to the technical field of computer system administration and, in one specific example, to implementing and/or configuring computer services, applications, user interfaces, and/or tools to facilitate analysis of a plurality of disparate data sets corresponding to a plurality of platforms deployed within one or more computer networks.

### BACKGROUND

Organizations may deploy multiple software applications within one or more computer networks to facilitate management of employees of the organization and tracking of job applicants. Such software systems may include a human resource information system (HRIS), which may be configured to, for example, store and manage confidential employee data, handle employee-centric human resource processes, such as those related to employee reviews and/or performance, and/or handle offboarding. Additionally, some HRIS may be configured to keep track of employee goals, compensation, and/or engagement. Such software systems may also include an applicant tracking system (ATS), which may be configured to collect and manage data related to employee onboarding. Traditionally, the HRIS and the ATS are completely separate systems.

### BRIEF DESCRIPTION OF THE DRAWINGS

Some embodiments are illustrated by way of example, and not limitation, in the figures of the accompanying drawings.

FIG. 1 is a network diagram depicting a system within which various example embodiments may be deployed.

FIG. 2 is a block diagram illustrating example modules of the service(s) of FIG. 1.

FIG. 3 is a block diagram illustrating a high-level view of an example Analytics API and example user interfaces that the example Analytics API is configured to power or otherwise support.

FIG. 4 is a block diagram further illustrating the high-level view of the example Analytics API and example user interfaces.

FIG. 5 is a block diagram further illustrating the high-level view of the example Analytics API and example user interfaces.

FIG. 6 is a block diagram illustrating an example method for accessing various analytics features of the system.

FIG. 7 is a block diagram illustrating an example Email user interface that acts as an entry point into the Analytics user interfaces from an external email system.

FIG. 8 is a block diagram illustrating an example People Summary user interface.

FIG. 9 is a block diagram illustrating an example Explorer user interface.

FIG. 10 is a block diagram illustrating an example Hiring Funnel user interface.

FIG. 11 is a block diagram illustrating an example Saved Reports user interface.

FIG. 12 is a block diagram illustrating an example Dashboard user interface.

FIG. 13 is a block diagram illustrating an example Saved Dashboards user interface.

FIG. 14 is a block diagram illustrating an example Custom Reporting user interface.

FIG. 15 is a block diagram illustrating an example Feedback Adoption user interface.

FIG. 16 is a block diagram illustrating an example Heatmap user interface.

FIG. 17 is a block diagram illustrating an example Admin Monthly user interface.

FIG. 18 is a block diagram illustrating an example Data Explorer user interface.

FIG. 19 is a block diagram illustrating further aspects of the example Data Explorer user interface.

FIG. 20 is a block diagram illustrating further aspects of the example Data Explorer user interface.

FIG. 21 is a block diagram illustrating further aspects of the example Data Explorer user interface.

FIG. 22 is a block diagram illustrating further aspects of the example Data Explorer user interface.

FIG. 23 is a block diagram illustrating further aspects of the example Data Explorer user interface.

FIG. 24 is a block diagram illustrating further aspects of the example Data Explorer user interface.

FIG. 25 is a block diagram illustrating further aspects of the example Data Explorer user interface.

FIGS. 26-34 is a block diagram illustrating various entities and their interconnections, including candidate profiles, employment history, educational background, and other relevant HR data points.

FIG. 35 is a block diagram illustrating a mobile device according to various example embodiments.

FIG. 36 is a block diagram of an example computer system on which methodologies and operations described herein may be executed, in accordance with an example embodiment.

### DETAILED DESCRIPTION

In the following description, for purposes of explanation, numerous specific details are set forth in order to provide an understanding of various embodiments of the present subject matter. It will be evident, however, to those skilled in the art that various embodiments may be practiced without these specific details.

It can be a difficult technical problem to determine how to interconnect data items in an ATS with data items in an HRIS, such that, for example, an organization can optimally improve its hiring practices for certain metrics related to employee performance and development, such as performance and/or retention.

The system described herein enables administrators (e.g., business leaders within an organization) to, using advanced system and/or data analytics tools, align their employees around their company's strategic priorities and activate every employee to execute against them. In example embodiments, the system helps an organization bridge one or more gaps between people operations and business operations through management of data items that represent or define Objectives and Key Results (OKRs) of an organization and the interlinking of such OKR data items with other data items, such as employee data in an HRIS and applicant data in an ATS.

In example embodiments, the system may be configured to be integrated with external systems, such as Jira and Salesforce, such that goals and OKRs are synchronized across the organization's systems such that, for example, the organization's progress measurement and reporting stays up to date in real-time without the need for manual updating.

In example embodiments, the system may provide one or more interactive graphical user interfaces (GUIs), such as Analytics Dashboards or other screens or pages, that may provide insights into various combinations of data, including data from disparate data sets stored and managed in separate platforms (e.g., an HRIS and an ATS). Such data may include HRIS data items, including data items pertaining to management of 1:1s, updates, feedback, goals, compensation, measurement, tracking, performance, and/or achievements, as well as ATS data items, including data items gathered during the applicant process (e.g., before certain individuals are hired as employees).

In example embodiments, the system may provide one or more interactive graphical user interfaces (GUIs), described herein, to facilitate interactive access to combinations of data items across multiple disparate systems, such as an HRIS and an ATS, which can lead to actionable insights that one or more users can take with respect to the system (and/or one or more subsystems of the system) to achieve one or more goals and/or OKRs more quickly, efficiently, and/or cheaply.

In example embodiments, the system may provide analytics tools for users. Users may be assigned one more roles or personas, such as administrator, chief of staff, employee, manager, manager of manager (“MoM”), executive, executive assistance, operations leader, department head, business leader, people manager, data consumer, and so on. Each user and/or role assigned to the user may be associated with different access rights. For example, various subsets of the interactive data analytics dashboards or other user interfaces described herein and/or various subsets of the data sets described herein may be accessible based on roles assigned to the users (e.g., to report on goal status and/or identify where they can take action to keep the company on track).

In example embodiments, the system (or “Analytics Application”) disclosed herein provides a technical solution for answering specific analytical questions (e.g., by pulling interesting data points from other individual products or subsystems of the system).

Each analytical question that the system answers may follow a similar time series pattern, e.g., a 2-dimension graph, with the Y-axis being the metric of the individual product or subsystem (e.g., number of updates, completed goals, etc.) and the X-axis being time.

In example embodiments, time is a central component throughout the Analytics Application experience and some or all metrics are controllable by a time filter. Secondary filters may be default attributes such as Department, Gender, Tenure, which may be used to further drill down on the metrics. In example embodiments, default attributes are attributes having a common semantic meaning across multiple subsystems of the system, wherein the common semantic meaning is defined at the system level (e.g., via one or more rules) and then adopted by each of the subsystems (e.g., via an Application Programming Interface (API)), as described herein.

In example embodiments, the GUI provides one or more user interface elements to provide customizability and filtering of pre-baked metrics and charts that follow the above time series pattern with an option to have saved views, as described herein.

In example embodiments, additional flexibility is provided via an API that users or customers can use to plug their own business intelligence tool(s) into.

In example embodiments, at least some of the data sets follow periodicity/seasonality. Thus, in example embodiments, the system also incorporates forecasting techniques.

In example embodiments, for each analytical question, one or more corresponding data points are isolated to individual products, modules, or other subsystems of the overall system.

There is complexity in joining subsystem data to employee data and/or applicant tracking data for incorporation into corresponding queries that are generated. In example embodiments, the system aggregates and/or filters subsystem specific data based on the employee state and/or the applicant state at the given point in time the action occurred.

A technological problem that may be encountered in such systems is the metric inconsistency problem. The metric inconsistency problem can be defined as not having standardized metric definitions and causing different teams/organizations/apps/subsystems to use different values for metrics that are meant to be semantically equivalent.

For example, the 1:1 number count, which may be meant to be a number of times an employee has met with a manager for a one-to-one meeting, may be treated differently across different subsystems, such that, for example, it means something different when surface on a Reporting page than it does when surface on an Adoption page of one or more user interfaces.

This problem may arise when, for example, the metrics are defined independently (e.g., with different definitions) across a plurality of subsystems and/or queried differently by one or more of the plurality of subsystems. This problem may further be aggravated if and when the underlying data is stored in different data stores with different data representations (e.g., which would make it difficult to write identical queries across subsystems).

This problem may lead to an inconsistent user experience (e.g., where one part of the overall system says one thing and another part of the overall system contradicts it, with respect to their representations of one or more data points. This could cause any other system or person relying on the data to suspect that the numbers are meaningless and/or lead them to drawing incorrect conclusions with respect to the data.

In example embodiments, there may be two components to this problem: (1) aligning on the definition and ensuring it is standardized across subsystems and (2) ensuring the systems delivers a consistent number given a fixed definition.

In example embodiments, the system mitigates this problem by providing proper product definitions that are codified in the system's code as well-defined abstractions and/or by avoiding code duplication/reinvention.

In example embodiments, each subsystem is configured to provide point-in-time “time travel” data. This data is filterable both by time range and through default/custom attributes. Metric consistency is ensured such that numbers have the same semantic meaning throughout the system. In example embodiments, the individual subsystems are configured to provide the required data via their own APIs.

In example embodiments, the APIs of the individual subsystems are wrapped in an Analytics API at the system level. In example embodiments, the Analytics API works with the APIs of the individual subsystems, contributing standardized point-in-time data APIs that expose subsystem data to help power Analytics use cases.

In example embodiments, each subsystem API is configured to output a list of all events that occurred within a time range (e.g., all feedback given or all employee versions).

The Analytics API then consumes the subsystem APIs in the Analytics Application and uses them to power individual subsystem or product Reporting pages to ensure metric consistency across the subsystems.

In example embodiments, these API methods may be called ad-hoc each time a customer loads a page. No special infrastructure is required and the system can operate in a stateless model, reducing memory, processing, and/or bandwidth requirements, thereby improving system performance (e.g., response times).

A clean abstraction and/or a standardized interface retrieves point-in-time time series data that the Analytics Application can expose for each individual product and/or subsystem. The system may be database agnostic since it operates at the API boundary layer.

This allows the system to codify and document the definitions of each metric (e.g., what is a “1:1”) in code. These definitions can be reused and ensure that the system attains metric consistency throughout the application.

In example embodiments, the system additionally provides a clean encapsulation of the underlying data sources (e.g., using Postgrese or DyanmoDB), which helps to address the schema change problem. The schema change problem may arise if a subsystem makes a change to an underlying data schema that breaks the interface. If a change of the underlying schema breaks the interface (e.g., at a subsystem level), this will be easy to isolate and test, because it will exist in each of the respective codebases corresponding to the subsystems.

In example embodiments, it is not a trapdoor decision to keep data separately stored and/or managed within each subsystem. In case the system is configured to use its own Data Warehouse, the abstraction layer should help isolate all the under-the-hood changes while keeping the service layer the same.

In short, the system is configured to mitigate and help control the metric inconsistency problem and also the schema change problem.

In the case the system needs to ‘join’ two different sets of metrics from two different products (e.g., engagement scores combined with 1:1 scores), the system may be configured to do so in its system code.

Since time is the common dimension across all metrics, the system can overlay multiple product data points by stitching together individual API calls (e.g., in Typescript land), without the need for any special database(s).

In example embodiments, complexity moves from queries (e.g., declarative SQL) into the system's maintained application code.

Administration—In example embodiments, an administration component or module handles coordination with the individual subsystems and/or product teams, as described herein.

Performance—Particularly for the ‘join’ cases, there might be a small performance penalty since the system does it in code and does not get to use specialized optimizations a database might have for them. This is a fair trade off since all data points will be sorted by time and for most cases, the system will be able to stitch them with one linear O(n) scan.

In example embodiments, the system introduces a caching layer to cache the API calls (e.g., as a first line of defense if performance becomes an issue). In example embodiments, if the system needs a data store, the standardized data APIs will help the system seed the database by doing time-travel. In example embodiments, the Analytics APIs are a building block that future systems can be built on top of. In example embodiments, additional tools (e.g., Spark) can be incorporated into the system for doing complex tasks, such as outlier analysis or any rolling aggregate analysis/benchmarking.

In example embodiments, the functionality of the system is exposed via a customer facing API, which can, for example, help power users pipe that to their own data warehouses.

Examples of subsystems that may be configured to work with the Analytics API, include employee identity tools (e.g., employee data), manager tools (e.g., 1:1, feedback, and updates), employee growth tools, employee engagement tools, employee goal-setting tools, and employee reviews tools.

A method of analyzing employment-related data from a plurality of disparate systems is disclosed. The employment-related data is retrieved from the plurality of disparate systems. The plurality of disparate systems includes a human resource information system (HRIS) and an applicant tracking system (ATS). The data comprises applicant information and employee performance metrics. The retrieved data is transformed by standardizing and aggregating the data into a unified dataset based on a common semantic model that aligns definitions and formats across the disparate systems. The unified dataset is analyzed to identify trends, patterns, or correlations within the data using one or more analytical or machine learning algorithms. The unified dataset or corresponding analyses are updated in real-time through an application programming interface (API).

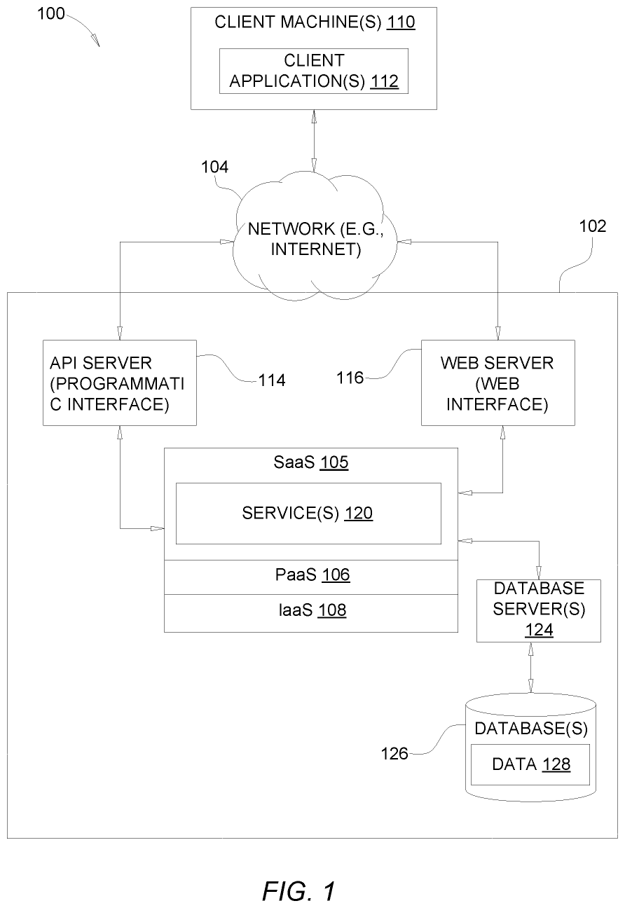

FIG. 1 is a network diagram depicting a system 100 within which various example embodiments may be deployed.

A networked system 102, in the example form of a cloud computing service, such as Microsoft Azure or other cloud service, provides server-side functionality, via a network 104 (e.g., the Internet or Wide Area Network (WAN)) to one or more endpoints (e.g., client machines 110). The networked system 102 is also referred to herein as “Lattice,” the “Analytics Application,” the “system,” or the “platform.” FIG. 1 illustrates client application(s) 112 on the client machines 110. Examples of client application(s) 112 may include a web browser application, such as the Internet Explorer browser developed by Microsoft Corporation of Redmond, Washington or other applications supported by an operating system of the device, such as applications supported by Windows, iOS or Android operating systems. Examples of such applications include e-mail client applications executing natively on the device, such as an Apple Mail client application executing on an iOS device, a Microsoft Outlook client application executing on a Microsoft Windows device, or a Gmail client application executing on an Android device. Examples of other such applications may include calendar applications and file sharing applications. Each of the client application(s) 112 may include a software application module (e.g., a plug-in, add-in, or macro) that adds a specific service or feature to the application.

An API server 114 and a web server 116 are coupled to, and provide programmatic and web interfaces respectively to, one or more software services, which may be hosted on a software-as-a-service (SaaS) layer or platform 105. The SaaS platform may be part of a service-oriented architecture, being stacked upon a platform-as-a-service (PaaS) layer 106 which, may be, in turn, stacked upon a infrastructure-as-a-service (IaaS) layer 108 (e.g., in accordance with standards defined by the National Institute of Standards and Technology (NIST)).

While the service(s) 120 are shown in FIG. 1 to form part of the networked system 102, in alternative embodiments, the service(s) 120 may form part of a service that is separate and distinct from the networked system 102.

Further, while the system 100 shown in FIG. 1 employs a cloud-based architecture, various embodiments are, of course, not limited to such an architecture, and could equally well find application in a client-server, distributed, or peer-to-peer system, for example. The various service(s) 120 (e.g., server applications) could also be implemented as standalone software programs. Additionally, although FIG. 1 depicts machines 110 as being coupled to a single networked system 102, it will be readily apparent to one skilled in the art that client machines 110, as well as client applications 112, may be coupled to multiple networked systems, such as payment applications associated with multiple payment processors or acquiring banks (e.g., PayPal, Visa, MasterCard, and American Express).

Web applications executing on the client machine(s) 110 may access the various service(s) 120 via the web interface supported by the web server 116.

Similarly, native applications executing on the client machine(s) 110 may accesses the various services and functions provided by the service(s) 120 via the programmatic interface provided by the API server 114. For example, the third-party applications may, utilizing information retrieved from the networked system 102, support one or more features or functions on a website hosted by the third party.

The service(s) 120 may be hosted on dedicated or shared server machines (not shown) that are communicatively coupled to enable communications between server machines. The service(s) 120 themselves are communicatively coupled (e.g., via appropriate interfaces) to each other and to various data sources, so as to allow information to be passed between the service(s) 120 and so as to allow the service(s) 120 to share and access common data. The service(s) 120 may furthermore access one or more databases 126 via the database servers 124. In example embodiments, various data items are stored in the database(s) 126, such as data 128, including goals data items and/or compensation data items described herein. In example embodiments, the data 128 includes one or more data items or metadata items that are viewable and/or editable via one or more user interfaces described herein. The data 128 may include data items that are interrelated, connected, or interlinked, to, for example, provide connections between ATS data items and HRIS data items, as described in more detail herein. In example embodiments, the data items may be stored and maintained in subsystems of the system and made accessible via one or more APIs, as described herein.

Navigation of the networked system 102 may be facilitated by one or more navigation applications. For example, a search application (as an example of a navigation application) may enable keyword searches of data items included in the one or more database(s) 126 associated with the networked system 102. Various other navigation applications may be provided to supplement the search and browsing applications.

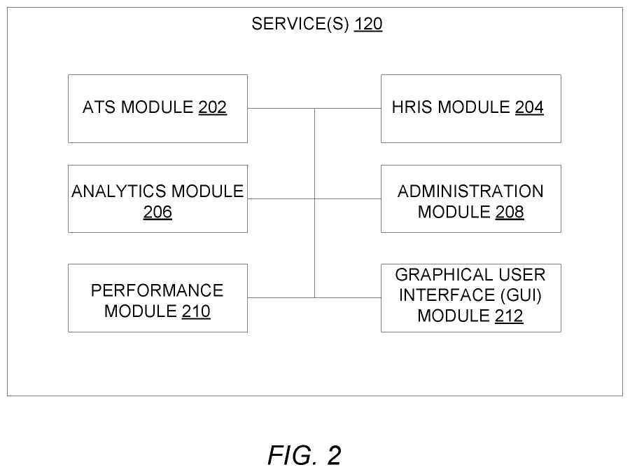

FIG. 2 is a block diagram illustrating example modules of the service(s) 120.

An ATS module 202 is configured to provide one or more services related to ATS data, including providing data related to hiring of individuals by an entity, including information pertaining to demographics, background checks, interviews, and so on, of applicants. Any information gathered about an applicant during the hiring prices may be included as data items, such as number of interviews, names of interviewers, feedback on the applicant provided by the interviewers, rating scores of the applicant provided by each interviewer or other parties encountering the applicant during the interview process, communications received from the applicant, and/or communications sent to the applicant, and so on.

An HRIS module 204 is configured to provide one or more services pertaining to HRIS data, including providing data related to current individuals associated with an entity, including employees, vendors, consultants, contractors, and/or other individuals. Any information pertaining to the associated individuals may be included as data items, including, for example, information pertaining to one-on-one (or “1:1”) meetings held between the employee and the employee's manager, feedback or reviews received on the individuals (e.g., from managers of the individuals), growth plans for the individuals, engagement of the individuals, goals of the individuals, or human resources data pertaining to the individuals.

An analytics module 206 is configured to receive one or more data items or metadata items (e.g., from one or more other modules, such as modules 204, 206, or 210). The analytics module 206 may interrelate, connect, or interlink such data items or metadata items to, for example, provide connections between ATS data and HRIS data (e.g., for subsequent presentation an in interactive dashboard interface and/or for generation of one or more action plans for improvement of one or more OKRs related to the data). For example, the analytics module 206 may uncover one or more changes that can be made to the interviewing process (e.g., uncover one or more questions and responses of particular importance) to increase a percentage of new hires that will eventually become high performers and/or be more easily retained (e.g., over one or more time frames).

An administration module 208 is configured to configured to provide one or more services pertaining to integration of data across disparate systems, such as ATS and HRIS data, which may be stored and maintained separately in one or more subsystems. Such services may include data standardization services and other services, as described herein.

A performance module 210 is configured to monitor system performance and/or perform one or more actions to improve system performance (e.g., when one or more performance metrics, such as those pertaining to processing power, memory, and/or bandwidth, are not being satisfied), such as by, for example, implementing a cache and/or incorporating third-party optimization tools, as described herein.

A dynamic graphical user interface (GUI) module 212 is configured to provide one or more specialized graphical user interfaces, as described herein, to, for example, allow users to manage, visualize, and/or link data (e.g., from one or more ATS or HRIS) and/or OKRs. In example embodiments, the one or more specialized user interfaces and/or elements included in the one or more specialized user interfaces, and/or combinations thereof, are asserted to be unconventional. Additionally, the one or more specialized user interfaces described include one or more features that specially adapt the one or more specialized user interfaces for devices with small screens, such as mobile phones or other mobile devices (e.g., by reducing a number of steps needed to access information and/or condensing data items and/or combinations of data items into representations that are suitable for small screens).

An automation module may be configured to automate various tasks, such as, for example, generating one or more action items for improving OKRs. Some automation may use machine learning. For example, a machine-learning model may be trained to generate a value predicting a performance of the organization with respect to one or more objectives, an action to take to improve the performance, and/or an indicator of one or more data items that will have the biggest impact on satisfaction of the one or more objectives. The inputs to the machine-learning model may include one or more relevant data items (e.g., from data 128 and/or data maintained and provided by one or more subsystems). The machine-learning model may then be applied to generate the value based on novel input data.

For example, a machine-learned model may be trained (e.g., with ATS data items and/or HRIS data items) to predict one or more employee scores, such as employee scores associated with OKRs (e.g., quality of hire, employee performance, and/or employee retention rate). This model may then be applied to novel ATS data to predict an applicant's performance or retention rate if hired. Other applications of the machine-learned models may be to use the models to determine action items that users can take with respect to the system that are most likely to improve the hiring process (e.g., improve the organization's performance with respect to one or more OKRs), identifying employees who, if involved in the hiring process, would most likely yield the highest quality of hire scores, identifying structural or procedural changes that, if made to the hiring process, would most likely improve the organization's performance with respect to one or more OKRs, and so on.

In example embodiments, the Unified Analytics API is designed to aggregate, standardize, and expose data from various subsystems within an organization's technology stack.

### Example Architecture Components

In example embodiments, the architecture is composed one or more of the following components that may work in concert to deliver a seamless analytics experience.

Subsystem APIs. In example embodiments, each subsystem, such as the ATS module 202 and the HRIS module 204, has its own API that serves as a conduit for the specific data it manages. These APIs are responsible for exposing the raw data in a structured format that can be consumed by the Unified Analytics API.

Data Standardization Engine. In example embodiments, an engine receives data from subsystem APIs and applies a set of rules and transformations to ensure consistency across all metrics. It resolves semantic differences and aligns data formats to create a unified data model.

Analytics Aggregator. In example embodiments, an aggregator component collects the standardized data from the Data Standardization Engine and compiles it into a comprehensive dataset that represents a holistic view of the organization's analytics landscape.

API Wrapper. In example embodiments, a wrapper acts as an outer layer of the Unified Analytics API. The wrapper encapsulates the functionality of the subsystem APIs and presents a single, cohesive interface to the end-users and external systems. It handles API requests, orchestrates data retrieval from the Analytics Aggregator, and formats the responses.

### Example Data Flow

In example embodiments, the data flow within the Unified Analytics API architecture is a multi-step process that ensures data integrity and accessibility.

Data Retrieval. Subsystem APIs retrieve raw data from their respective data stores, as depicted in FIG. 1, where the database(s) 126 are accessed via the database servers 124.

Data Standardization. The raw data is transmitted to the Data Standardization Engine, where it undergoes normalization to align with the unified data model.

Data Aggregation. The standardized data is then passed to the Analytics Aggregator, which compiles the data from various subsystems into a comprehensive dataset.

Data Exposure. The API Wrapper receives requests from client applications 112 (as shown in FIG. 1) and interacts with the Analytics Aggregator to retrieve the relevant data. It then formats and returns the data to the requesting client application in a consumable format.

Interaction with Subsystem APIs:

The Unified Analytics API interacts with subsystem APIs through a series of orchestrated calls that are triggered based on user requests or scheduled processes. The interaction may be governed by one or more of the following principles.

Request Handling. When a request is received by the API Wrapper, it determines the necessary subsystem APIs to call based on the data required to fulfill the request.

Parallel Processing. To optimize performance, the Unified Analytics API can initiate parallel calls to multiple subsystem APIs, allowing for concurrent data retrieval.

Data Synthesis. Once the data is received from the subsystem APIs, it is synthesized by the Data Standardization Engine and Analytics Aggregator to produce a dataset that reflects a unified view of the requested metrics.

Response Generation. The API Wrapper then generates a response that includes the synthesized data, which is sent back to the client application in a structured format, such as JSON or XML.

In example embodiments, the Unified Analytics API may include one or more algorithms, such as the example algorithms described below, designed to transform and standardize data from disparate sources, ensuring uniformity across the system.

Semantic Alignment Algorithm. Input: Raw data from subsystem APIs with varying semantic definitions. Process: The algorithm maps each data point to a standardized semantic model. It uses a dictionary of terms and relationships that define how each term from the subsystems corresponds to the standardized model. Output: Semantically aligned data points that have a consistent meaning across the system.

Format Normalization Algorithm. Input: Data in various formats (e.g., date-time formats, numerical representations, string encodings) from subsystem APIs. Process: The algorithm applies a set of rules to convert data into a uniform format. For dates, it might convert all inputs to ISO 8601 format; for numbers, it might standardize on decimal places or rounding rules. Output: Data in a consistent format ready for further processing or presentation.

Data Deduplication Algorithm. Input: Potentially redundant data entries from multiple subsystems. Process: The algorithm identifies duplicates using key attributes, applies a rule-based system to determine the authoritative source, and merges or discards duplicates accordingly. Output: A deduplicated dataset with each unique data point represented once.

In example embodiments, once data is standardized, the Unified Analytics API processes it to generate actionable insights. One or more of the following techniques may be used for data processing.

Time Series Analysis Technique. Input: Standardized time-stamped data from various subsystems. Process: The method involves applying statistical techniques to identify trends, patterns, and anomalies over time. It may use moving averages, exponential smoothing, or regression analysis to forecast future values. Output: Time series insights that inform decision-making and strategy development.

Correlation Analysis Technique. Input: Multiple standardized data sets intended to be analyzed for interdependencies. Process: The method calculates correlation coefficients to measure the strength and direction of the relationship between different data sets. Output: A correlation matrix that highlights significant correlations, which can be used to infer causality or inform cross-functional analytics.

Data Aggregation Technique. Input: Standardized data requiring summarization or roll-up. Process: The method applies aggregation functions such as sum, average, count, min, and max to compile data at a higher level of granularity, based on specified attributes or dimensions. Output: Aggregated data that provides a summarized view suitable for dashboard displays or high-level reports.

### Example Use Cases

The Unified Analytics API can be used to synthesize complex data from multiple sources into actionable insights, thereby supporting strategic decision-making and operational efficiency, as illustrated by the following example use cases.

Talent Acquisition Optimization. Scenario: An organization seeks to improve its talent acquisition process by identifying the characteristics of applicants who become high-performing employees. Application of Unified Analytics API: The API aggregates applicant data from the ATS and performance data from the HRIS. The Data Standardization Engine processes the data to align metrics such as “time to hire” and “employee performance ratings.” The Analytics Aggregator compiles a dataset correlating applicant attributes with subsequent job performance. HR managers use the interactive GUIs to identify patterns and adjust recruitment strategies accordingly. Outcome: The organization refines its hiring criteria, leading to a more effective talent acquisition process and higher overall employee performance.

Employee Retention Analysis. Scenario: A company experiences higher than desired turnover rates and wishes to understand the factors contributing to employee attrition. Application of Unified Analytics API: The API collects data on employee tenure, engagement scores, and exit interview feedback. The Correlation Analysis technique identifies relationships between engagement levels and employee longevity. The Time Series Analysis technique provides insights into attrition trends over time. Decision-makers access customized dashboards to develop targeted retention programs. Outcome: The company implements new employee engagement initiatives, resulting in reduced turnover and improved retention rates.

Diversity and Inclusion Metrics Tracking. Scenario: An enterprise commits to enhancing diversity and inclusion within its workforce and needs to track progress against its goals. Application of Unified Analytics API: The API integrates demographic data from HRIS with recruitment and promotion data from ATS and performance management systems. The Data Aggregation technique summarizes diversity metrics across departments and job levels. The interactive GUIs allow executives to monitor diversity and inclusion metrics in real-time. The system generates reports for stakeholders demonstrating progress and areas for improvement. Outcome: The enterprise makes data-driven decisions to promote diversity and inclusion, leading to a more equitable workplace culture.

Real-Time Performance Dashboard for Executives. Scenario: Executives require a real-time overview of the organization's performance across various HR metrics. Application of Unified Analytics API: The API pulls live data from multiple subsystems, including recruitment, onboarding, employee development, and compensation. The Data Deduplication technique ensures that the dashboard displays unique and accurate data points. Executives access a real-time performance dashboard that provides a comprehensive view of HR metrics. The dashboard enables quick decision-making based on the latest data. Outcome: Executives stay informed with up-to-date HR analytics, enabling them to swiftly address issues and capitalize on opportunities.

In example embodiments, the Unified Analytics API includes one or more endpoints, such as retrieve, standardize, aggregate, analyze, update, and delete endpoints. The retrieve endpoint is used for retrieving data from the system. It supports various query parameters to specify the data required. The standardize endpoint is responsible for standardizing raw data inputs from various subsystems into a unified format. The aggregate endpoint aggregates data from multiple sources, providing a summarized view based on the specified parameters. The analyze endpoint performs advanced analytics on the data, such as trend analysis, correlation, and forecasting. The update endpoint allows for updating existing data records within the system. The delete endpoint facilitates the deletion of data records from the system.

In example embodiments, The API accepts requests in JSON format, which includes the necessary parameters and filters to define the data retrieval or manipulation operation. And the API returns responses in JSON format, providing a structured representation of the data, analysis results, or confirmation of the requested operation.

Parameters may include those for specifying the date and time range for the data retrieval, defining the subsystems from which to retrieve data (e.g., ATS or HRIS), list specific metrics to be included in the data retrieval or analysis (e.g., hiring time, employee retention, diversity index), determine the attributes by which to group the data (e.g., department or job level), one or more criteria for filtering the data (e.g., a department or status), an order for sorting the returned data (e.g., ascending or descending for a particular metric).

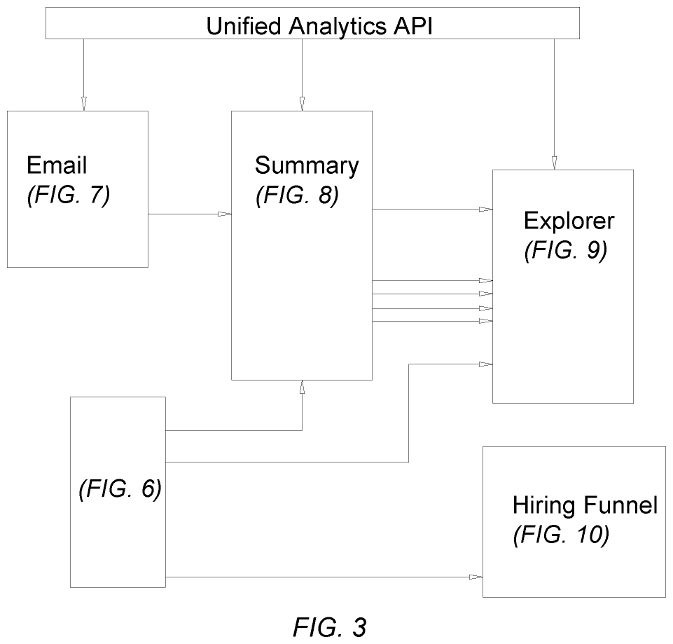

FIG. 3 is a block diagram illustrating a high-level view of an example Analytics API (e.g., “Unified Analytics API”) and example user interfaces that the example Analytics API is configured to power or otherwise support, including one or more user interfaces related to data items pertaining to Email, People Summary, Explorer, Hiring Funnel, Quality of Hire, Driver Analysis, and/or Heatmap user interfaces, as described herein. One or more of these user interfaces may be interconnected, such that they are accessible to and/or from one another (e.g., through activation of one or more interactive user interface elements) as depicted and described herein. The Unified Analytics API depicted in FIG. 3 serves as the backbone for a suite of interactive graphical user interfaces (GUIs). These GUIs, including Analytics Dashboards and other screens, are designed to provide users with insights into various combinations of data. The API facilitates the integration and analysis of data from disparate systems, enabling users to derive actionable insights and make informed decisions.

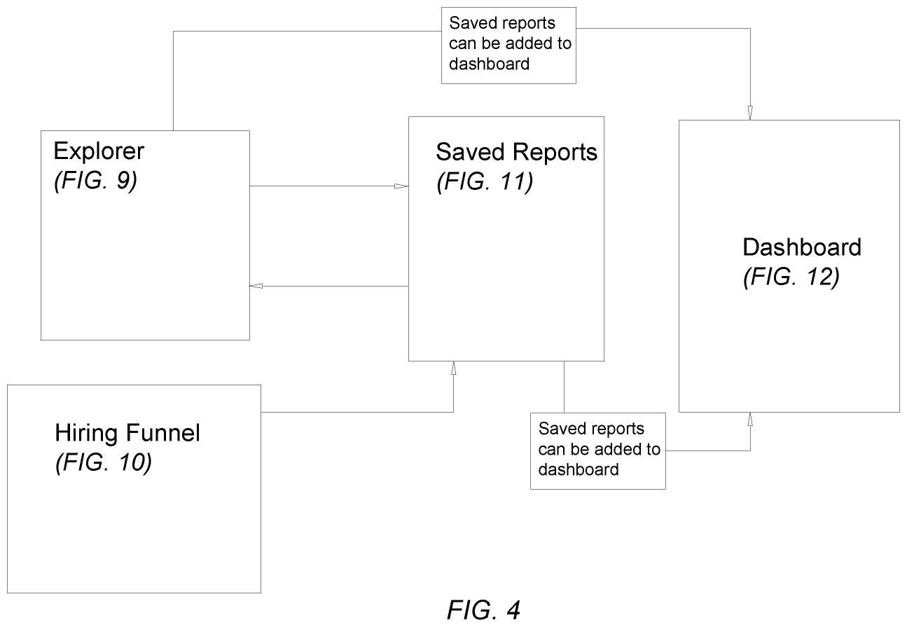

FIG. 4 is a block diagram further illustrating the high-level view of the example Analytics API and example user interfaces. The Explorer user interface and the Hiring Funnel user interfaces are connected from corresponding portions of the user interfaces of FIG. 1 and connected to various additional user interfaces, including a user interface for Saving Reports, which are then added to a Dashboard, as described herein. FIG. 4 illustrates the interconnected nature of the Analytics API's GUIs, emphasizing the ease with which users can navigate between different analytical views. The Explorer and Hiring Funnel interfaces are directly accessible, allowing users to delve deeper into specific data sets and to customize reports that can be added to dashboards for a comprehensive overview.

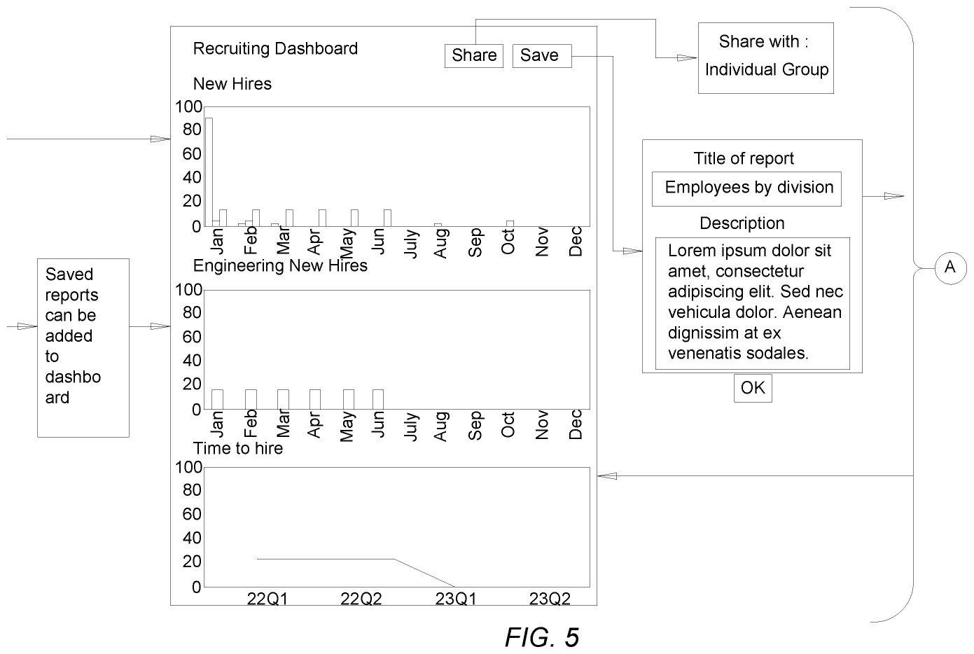

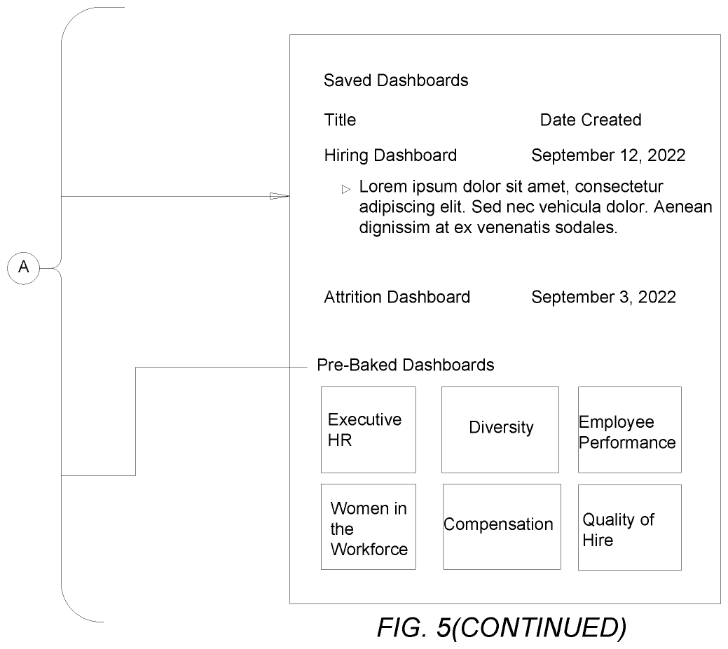

FIG. 5 is a block diagram further illustrating the high-level view of the example Analytics API and example user interfaces. The Dashboard user interface is connected from the Explorer user interface and the Saved Reports user interface to various additional user interfaces, as depicted, including a Sharing user interface and a Saved Dashboards user interface. In FIG. 5, the Dashboard user interface serves as a centralized platform for visualizing and interacting with a variety of analytics modules. It showcases the system's ability to compile and display data from multiple sources in a user-friendly format, enabling quick access to key metrics and trends.

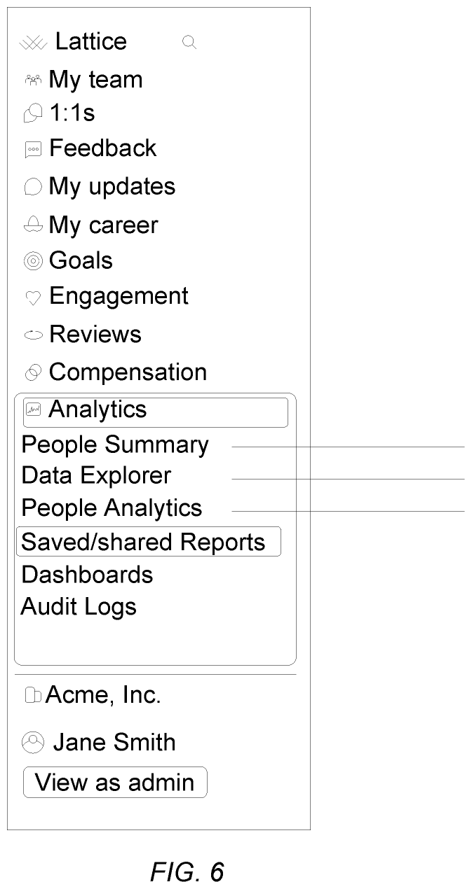

FIG. 6. is a block diagram illustrating an example toolbar or navigation user interface that is configured to provide a user with access to various other user interfaces of the system. The toolbar user interface has an analytics section with interactive user interface elements configured to provide access to various user interfaces powered by the Analytics API, including the People Summary, Data Explorer, People Analytics, Saved/Shared Reports, Dashboards, and Audit Logs user interfaces. In example embodiments, the Analytics API may access one or more data items from one or more subsystems, including an ATS, HRIS, and/or subsystems corresponding to 1:1s, Employee Feedback, Updates, Growth, Goals, Engagement, Reviews, and Compensation, and provide them in the Analytics user interfaces for selection, manipulation, or transformation, including combining and/or filtering, as described herein. The toolbar or navigation user interface shown in FIG. 6 provides a streamlined method for accessing various analytics features of the system. It highlights the system's modular design, allowing users to easily switch between different analytical tools such as People Summary, Data Explorer, and Dashboards, all powered by the Unified Analytics API.

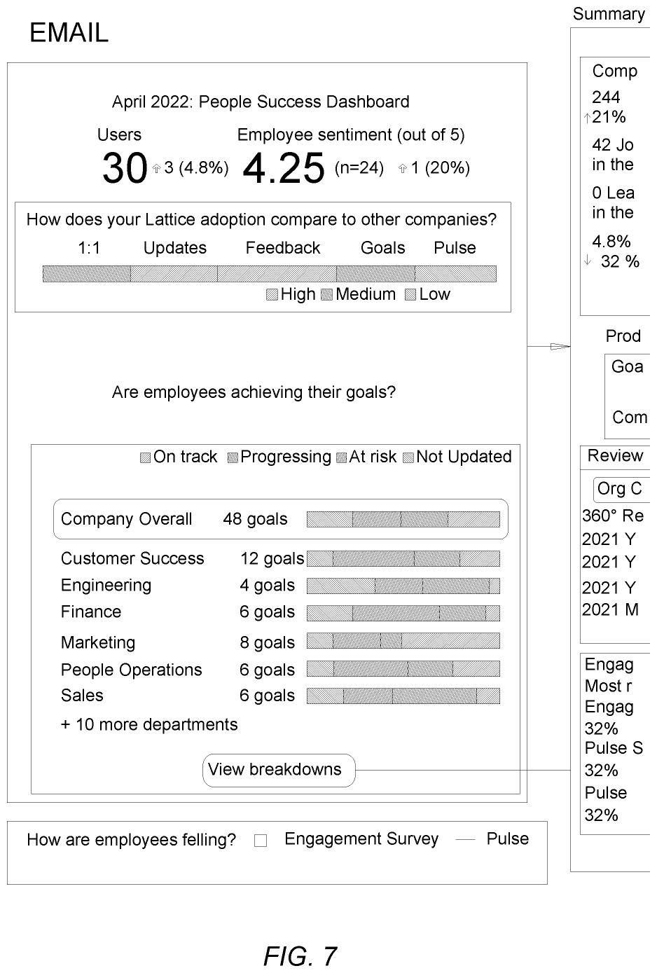

FIG. 7 is a block diagram illustrating an example Email user interface in more detail. In example embodiments, the Email user interface may be included in one or more email messages sent to one or more users of the system. In example embodiments, the Email user interface may serve as an entry point into the Analytics user interfaces from an external system, such as a client device. The Email user interface may include a subset of one or more data points from one or more underlying systems, including an ATS and/or an HRIS. The data items included in the Email user interface may be accessed via one or more calls to the Analytics API, which, in turn, may serve as a wrapper for one or more user interfaces specific to each subsystem. For example, the Email user interface may include information pertaining to employee sentiment and may have a breakdown of data across groups within the organization. Interactions with the Email user interface by a user, such as clicking on a portion of the user interface or on a user interface element (e.g., a button), may cause one or more additional Analytics user interfaces to be generated and transmitted (e.g., for presentation on a client device). The one or more additional Analytics user interfaces may include further data points relevant to data items that are interacted with on the Email user interface, as described herein. FIG. 7 details an Email user interface that acts as an entry point into the Analytics user interfaces from an external email system. It demonstrates the API's capability to embed analytics directly into communication channels, providing users with immediate insights and the option to engage with more detailed analytics through the system's GUIs.

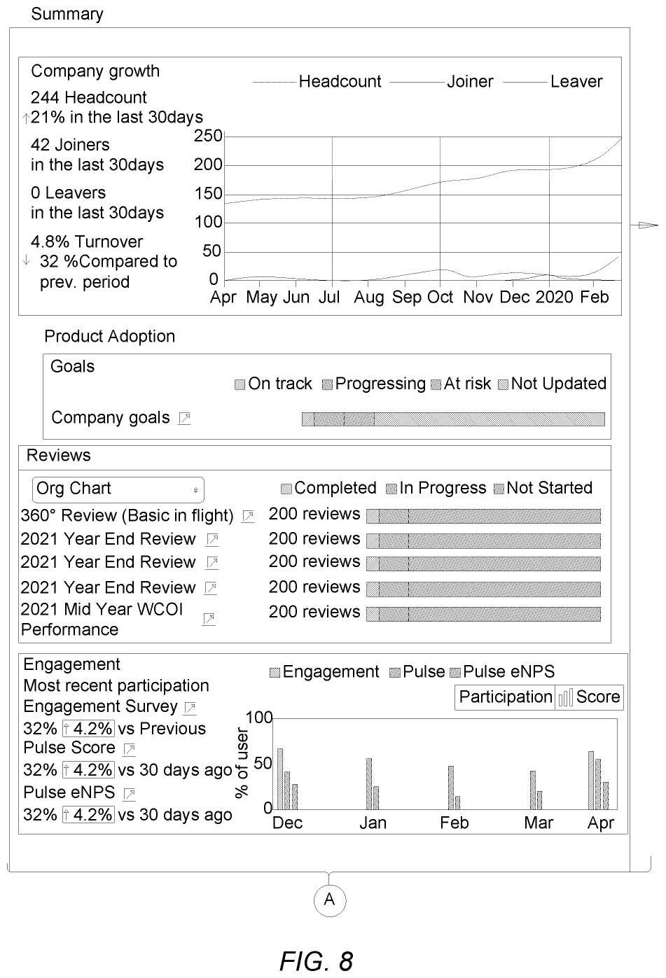

FIG. 8 is a block diagram illustrating an example People Summary user interface in more detail. The People Summary page may include one or more data items pertaining to one or more combinations of ATS data items and HRIS data items, including information pertaining to engagement of employees across the company, growth of the company, product adaptation, feedback, Updates, 1:1s, employee growth, and so on. Interaction with various portions of data may cause further information to be displayed (e.g., in an additional user page, such as the Explorer page), as indicated. The People Summary user interface depicted in FIG. 8 provides a high-level view of organizational metrics, enabling users to quickly assess key performance indicators. The interface allows for the exploration of data points in greater detail, facilitating a deeper understanding of the underlying trends and factors.

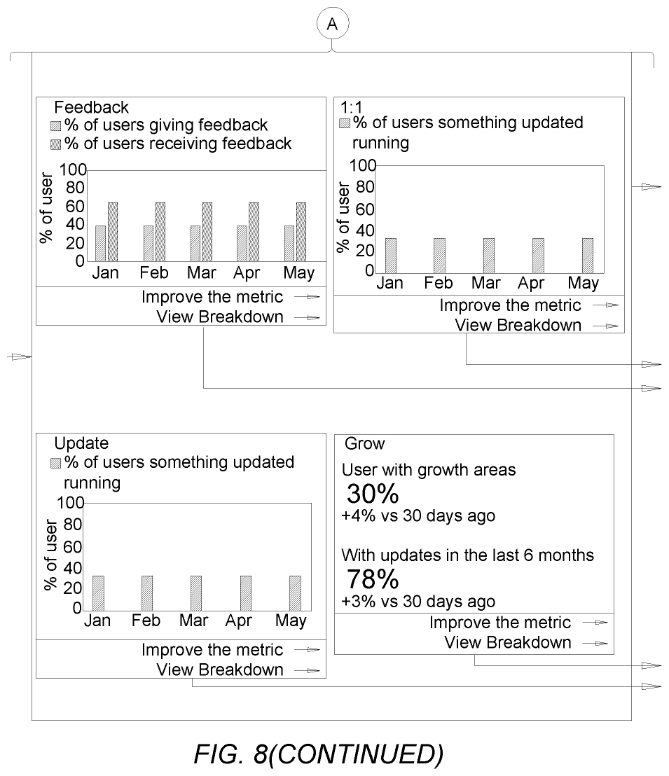

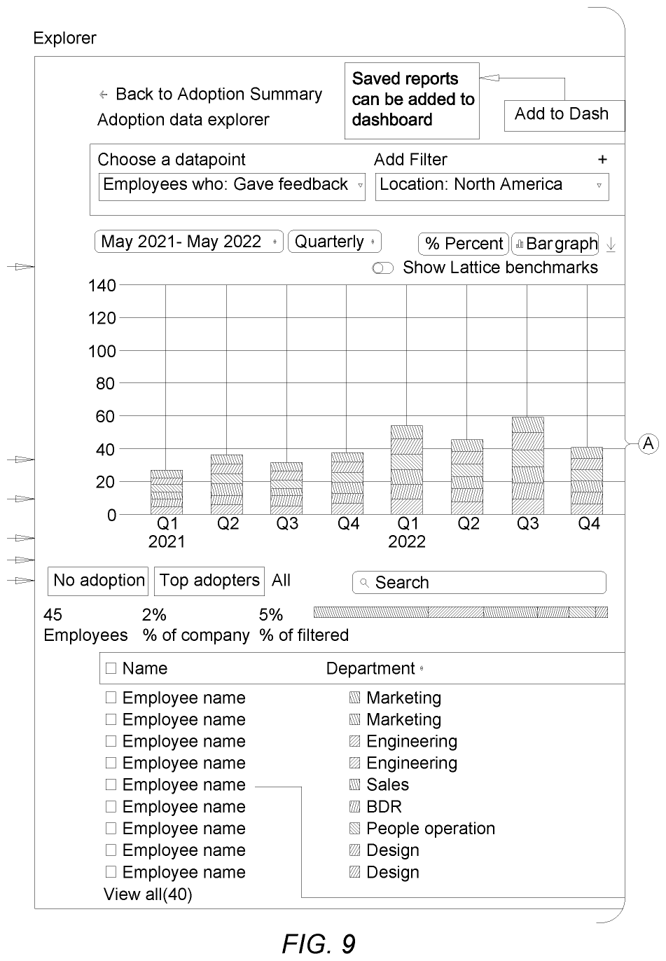

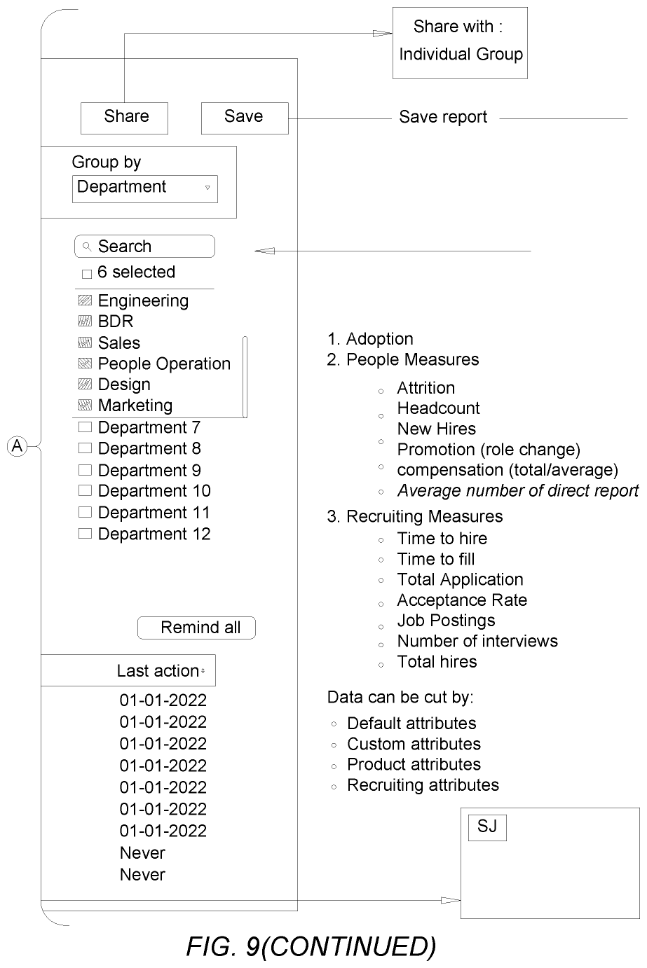

FIG. 9 is a block diagram illustrating an example Explorer user interface in more detail. The Explorer page may present an interactive screen in which information pertaining to any of the data from the People Summary page may be reviewed in more detail. Such information may include, for example, adoption data, people measures (e.g., attrition, headcount, new hires, promotion and/or role changes, compensation (e.g., total/average), average number of direct reports) and/or recruiting measures (e.g., time to hire, time to fill, total applications, acceptance rate, job postings, number of interviews, and/or total hires). These data items may be taken from and/or combined with ATS data items and HRIS data items (e.g., via one or more APIs, as described herein) in this user interface and other user interfaces described herein. In example embodiments, in this user interface (and others described herein), the data items can be cut by default attributes (well-defined attributes that are semantically consistent across subsystems, as described above), custom attributes (attributes defined by a customer), product-specific attributes, and/or recruiting attributes. FIG. 9 presents the Explorer user interface, which offers a dynamic and interactive environment for analyzing specific data points. Users can filter, sort, and group data to uncover patterns and insights, with the ability to save customized reports and add them to dashboards for ongoing monitoring.

The Explorer user interface may include one or more interactive user interface elements for navigating further through the data (e.g., for drilling up or down or accessing connected pages/screens). For example, from the Explorer page, clicking on particular employee may cause a profile page for that employee to be presented (e.g., in a separate user interface).

Data may be interactively cut, filtered, organized, or otherwise manipulated. Then the data may be added to a dashboard, shared, or saved, as depicted.

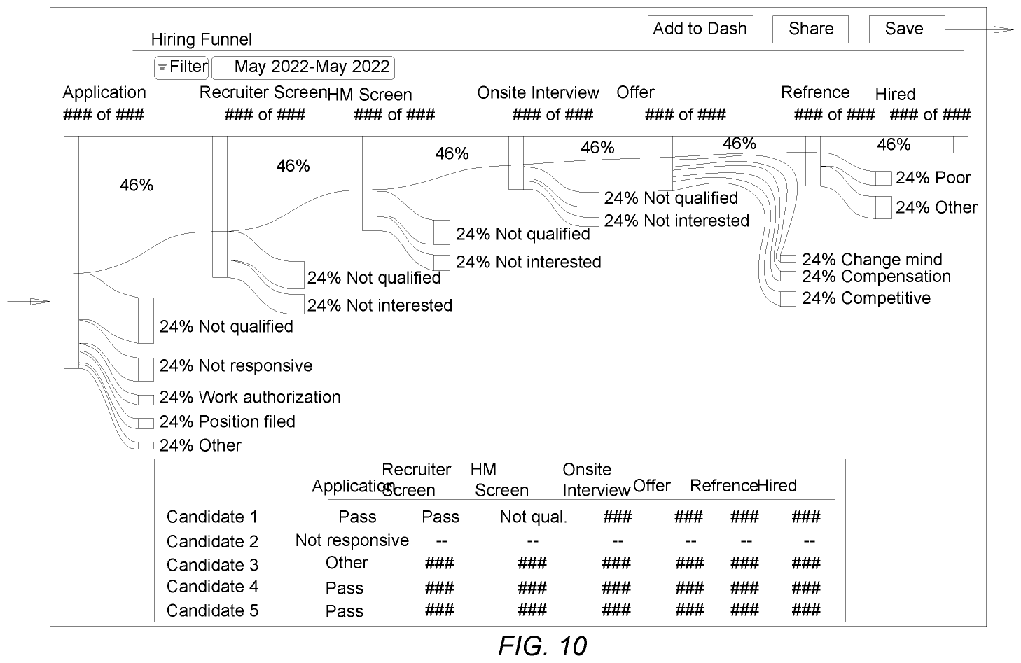

FIG. 10 is a block diagram illustrating an example Hiring Funnel user interface in more detail. The Hiring Funnel screen (e.g., including data from an ATS) may be used to interactively view, filter, or organize ATS data items and/or add the data items to a dashboard, share the items, or save the items, as depicted. The Hiring Funnel user interface shown in FIG. 10 enables users to visualize and interact with the recruitment process. It provides a detailed breakdown of the hiring stages, allowing users to identify bottlenecks and optimize the funnel for efficiency.

Reports generated from other user interfaces or pages may be saved in a repository that includes information about the reports, including their sources, dates created, and/or information contained. The interactive user interface may allow access to each report by clicking on the report.

The Hiring Funnel user interface may provide an interactive visual representation of the report as it was previously organized, filtered, and prepared. The user interface itself may be further shared or saved, as indicated.

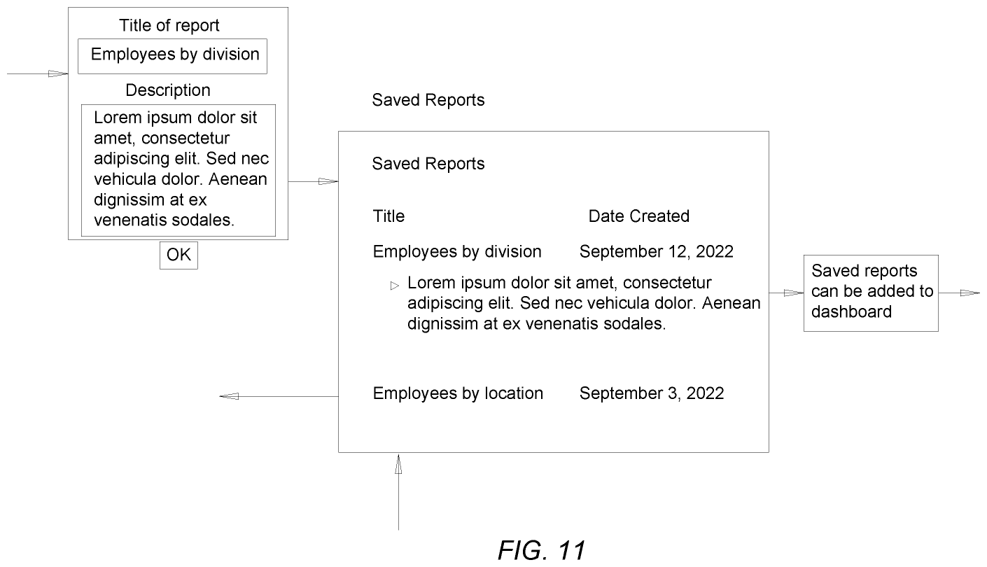

FIG. 11 is a block diagram illustrating an example Saved Reports user interface in more detail. The Saved Reports user interface may include a repository of reports (e.g., from the Explorer or Hiring Funnel user interfaces) previously saved. Reports may be accessed by clicking on the report. Additionally, reports may be added to one or more dashboards, as indicated. In FIG. 11, the Saved Reports user interface acts as a repository for user-generated reports, offering easy access and management of saved analyses. Users can review, share, or further refine these reports, integrating them into dashboards for a consolidated view of analytics.

FIG. 12 is a block diagram illustrating an example Dashboard user interface in more detail. The Dashboard user interface may include one or more visual depictions, such as one or more charts, corresponding to one or more data items included in one or more of the saved reports. The reports included on the dashboard may be a subset of reports selected from the set of saved reports and may be added to the dashboard, as indicated. The dashboards may be shared or stored as saved dashboards, as indicated. The Dashboard user interface in FIG. 12 is a customizable display that aggregates selected reports into a single view. It allows users to share insights with others and save customized dashboards for future reference, streamlining the decision-making process.

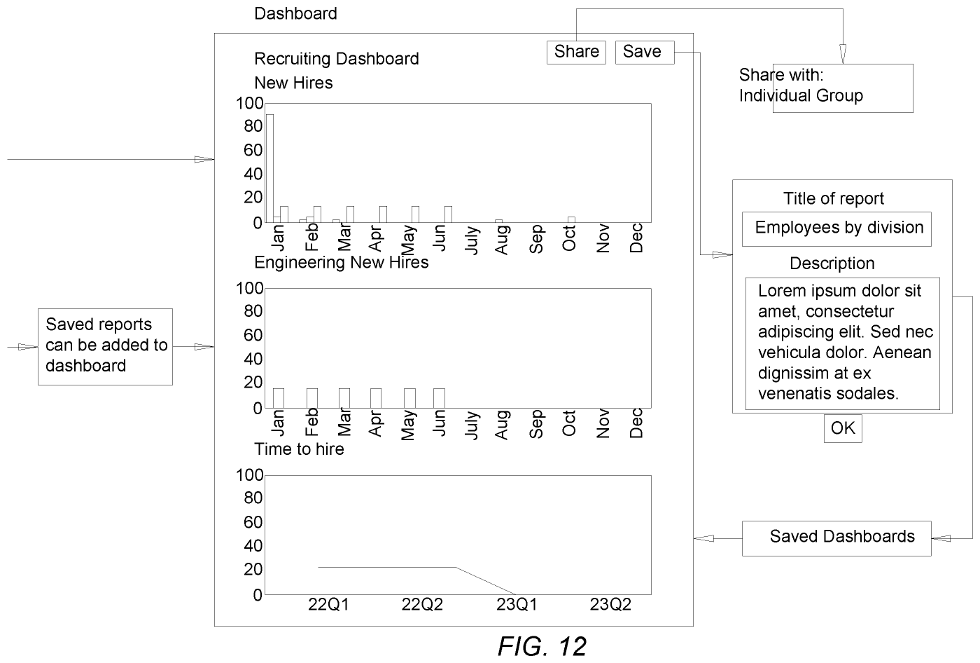

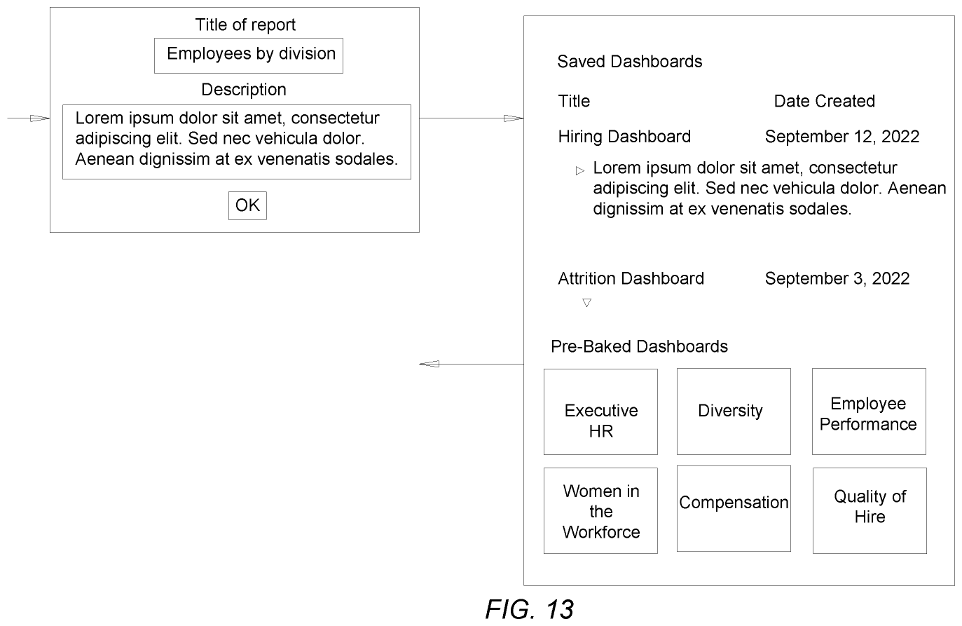

FIG. 13 is a block diagram illustrating an example Saved Dashboards user interface in more detail. The user interface may allow access to one or more custom dashboards, such as one or previously saved dashboards (e.g., hiring dashboard and/or attrition dashboard). Additionally, the user interface may allow access to one or more pre-baked dashboards, such as dashboards for Executive HR, Diversity, Employee Performance, Women in the Workforce, Compensation, and Quality of Hire. FIG. 13 illustrates the Saved Dashboards user interface, where users can access and manage a collection of pre-configured and user-created dashboards. This interface highlights the system's flexibility in providing both standardized and custom analytics solutions to meet diverse organizational needs.

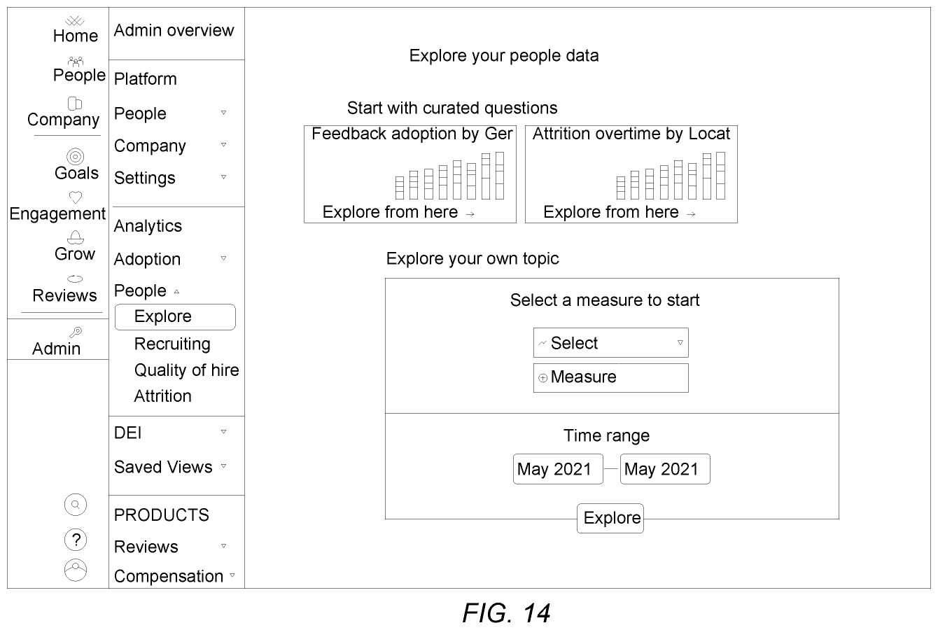

FIG. 14 is a block diagram illustrating an example Custom Reporting user interface. The Custom Reporting user interface may be used to provide a more welcoming and easier starting point (e.g., in comparison to the Email Summary or other user interfaces connected to the Explorer user interface). In example embodiments, the Custom Reporting user interface provides an option to select a measure to start (e.g., Feedback Adoption) and a time range. Clicking on the Explore button brings up the Explorer page for the Feedback Adoption measure. The Custom Reporting user interface depicted in FIG. 14 simplifies the creation of tailored reports by guiding users through the selection of measures and time ranges. It serves as a starting point for generating in-depth analyses, demonstrating the system's user-centric design.

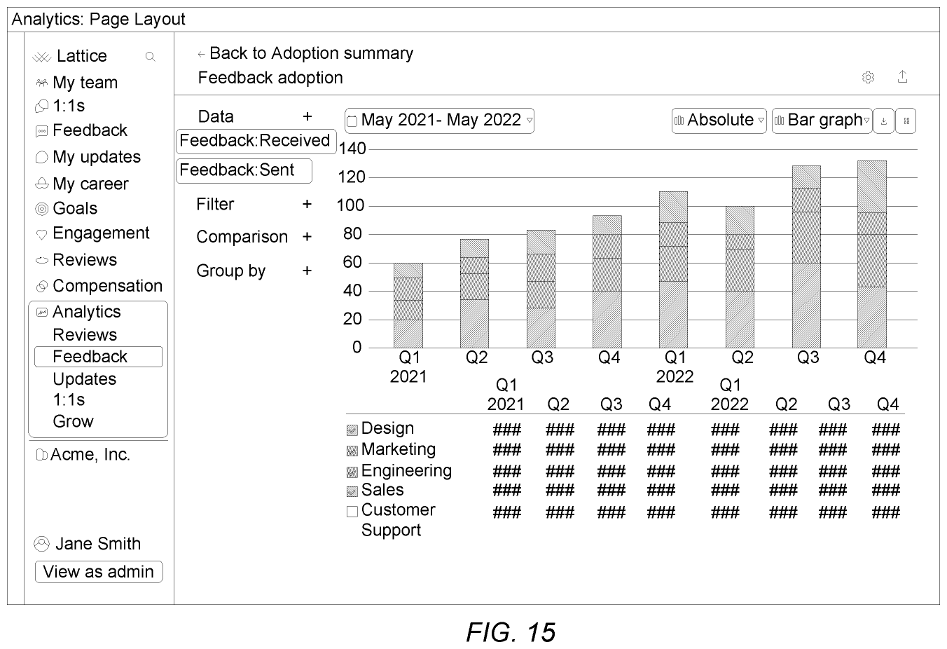

FIG. 15 is a block diagram illustrating an example Feedback Adoption user interface. In example embodiments, one or more data items pertaining to feedback adoption are shown for a particular date range. The data may be broken down by functional groups within the organization (e.g., based on filters applied). The interactive user interface is configured to allow the data to be grouped (or “cut”) by other data items (e.g., combinations of HRIS and/or ATS data, as described herein). In FIG. 15, the Feedback Adoption user interface provides a focused view on how feedback is utilized within the organization. It allows users to examine adoption rates and effectiveness, supporting continuous improvement in feedback practices.

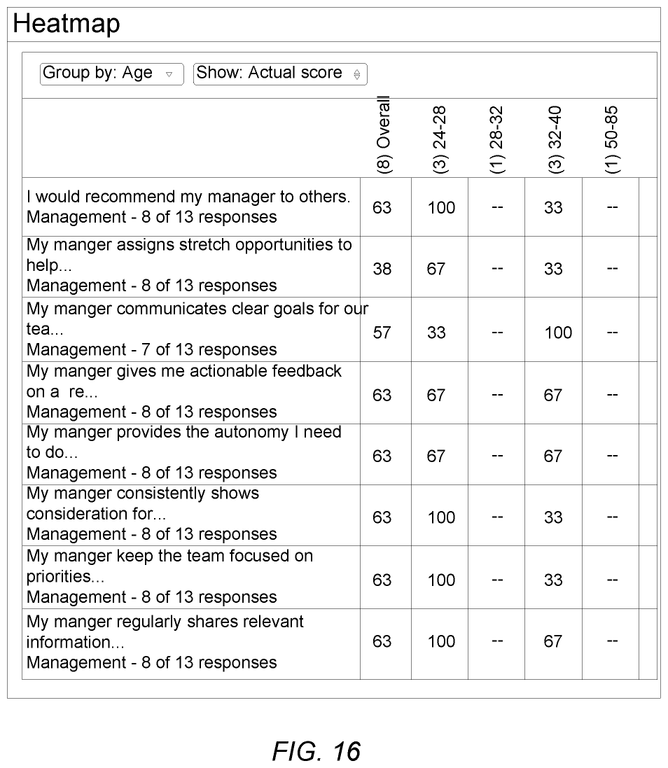

FIG. 16 is a block diagram illustrating an example Heatmap user interface. In example embodiments, the Heatmap user interface provides an interactive view of a subset of data (e.g., a manager's performance), including color indicators of changes in scores (e.g., positive and/or negative) since a previous viewing of the data. As with other user interfaces described herein, the subset of data may include one or more combinations of ATS data items and/or HRIS data items. The Heatmap user interface shown in FIG. 16 offers a visual representation of data across various dimensions, using color coding to highlight areas of interest. This interface aids in the quick identification of patterns and outliers, facilitating targeted analysis.

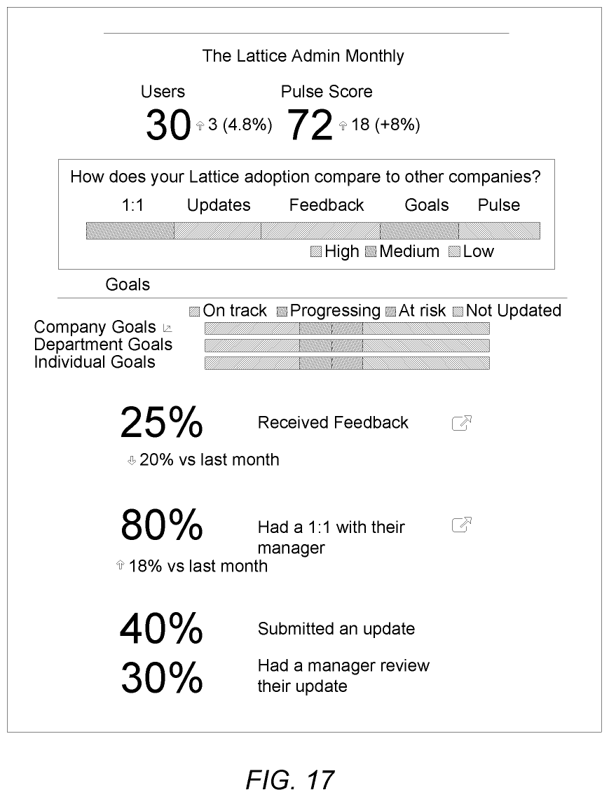

FIG. 17 is a block diagram illustrating an example Admin Monthly user interface. In example embodiments, the Admin Monthly user interface may provide information pertaining to adoption (e.g., of the system and/or one or more of its subsystems by employees), progress toward department goals and/or individual goals, feedback, 1:1s, updates, and/or manager performance, as shown. The user interface aggregates key metrics into a monthly snapshot for administrators and provides a concise overview of system adoption and goal progress, enabling administrators to track and address issues promptly.

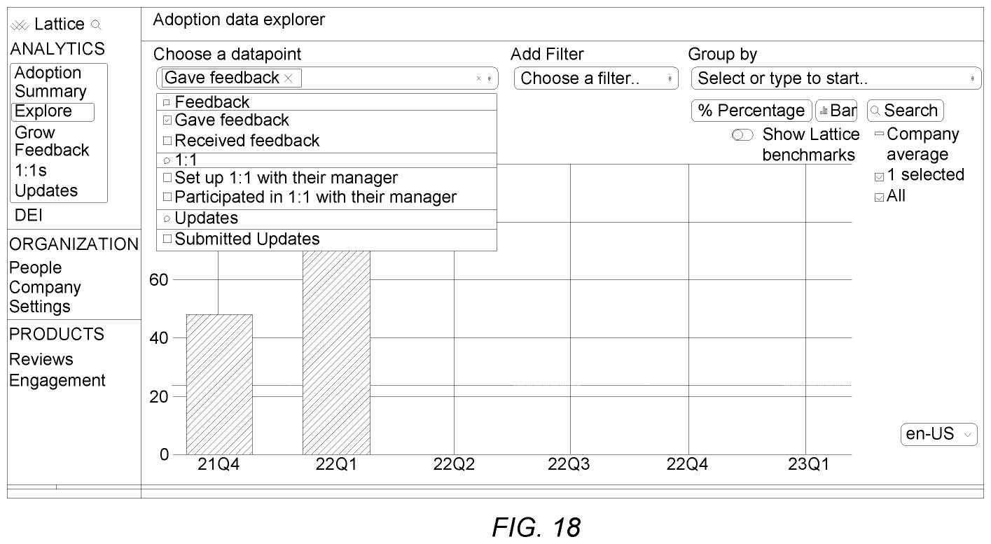

FIG. 18 is a block diagram illustrating an example Data Explorer user interface. In example embodiments, the Data Explorer user interface may replace or be accessible from FIG. 9. The Data Explorer user interface may allow selection of one or more data points discussed herein for further manipulation and/or saving as a report and/or a dashboard. Interactive components on the dashboard may allow for filtering the data, grouping (or cutting) the data (e.g., based on other data items, such as ATS or HRIS data items), and/or specifying a style of the presentation (e.g., bar, or line graphs, etc.), as depicted. The Data Explorer user interface depicted in FIG. 18 allows users to delve into specific data points, offering a granular view of the selected metrics. It supports complex data manipulation, including filtering and grouping, to generate customized insights.

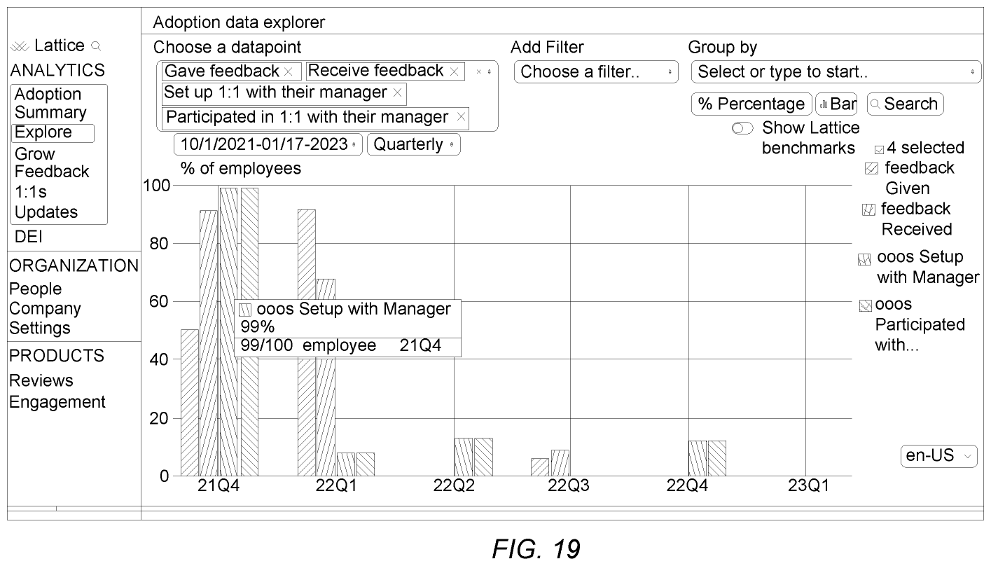

FIG. 19 is a block diagram illustrating further aspects of the example Data Explorer user interface. The Data Explorer may allow quick editing of one or more data points that are included (e.g., via checking or unchecking the items in the drop-down menu and/or activating the “X” icon next to a data point to remove it) discussed herein for presentation on a dashboard. Interactive components on the dashboard allow for filtering the data, cutting the data, and specifying a style of the presentation (e.g., bar, or line graphs, etc.). In FIG. 19, the Data Explorer user interface demonstrates the system's capability to handle real-time data editing and visualization. Users can interactively modify the data points displayed, tailoring the analytics to their immediate needs.

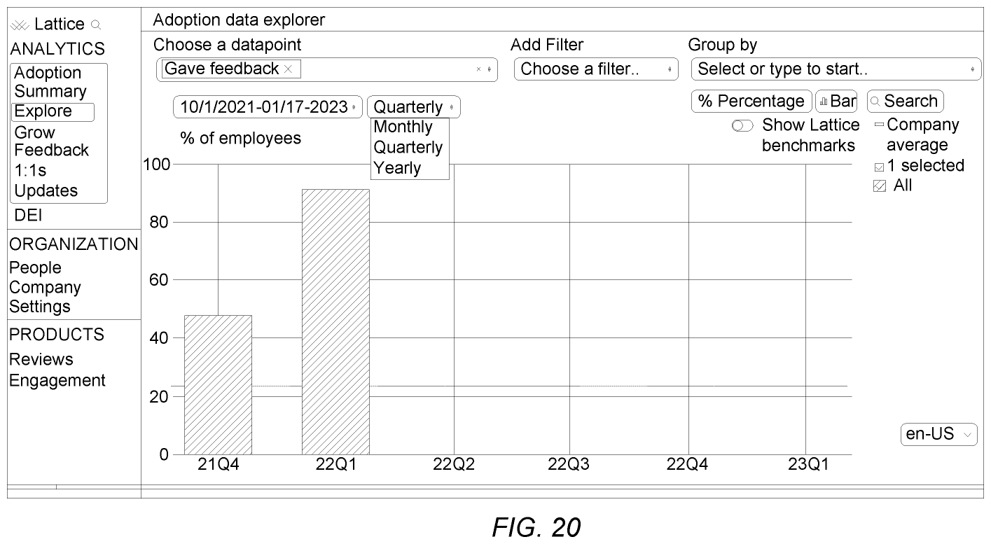

FIG. 20 is a block diagram illustrating further aspects of the example Data Explorer user interface. The Data Explorer user interface may allow for a time range to be set (e.g., quarterly, yearly) or a specific date range to be set. FIG. 20 showcases the Data Explorer user interface's ability to accommodate different time ranges for analysis. Users can set specific time frames to focus their analysis on relevant periods, enhancing the precision of the insights generated.

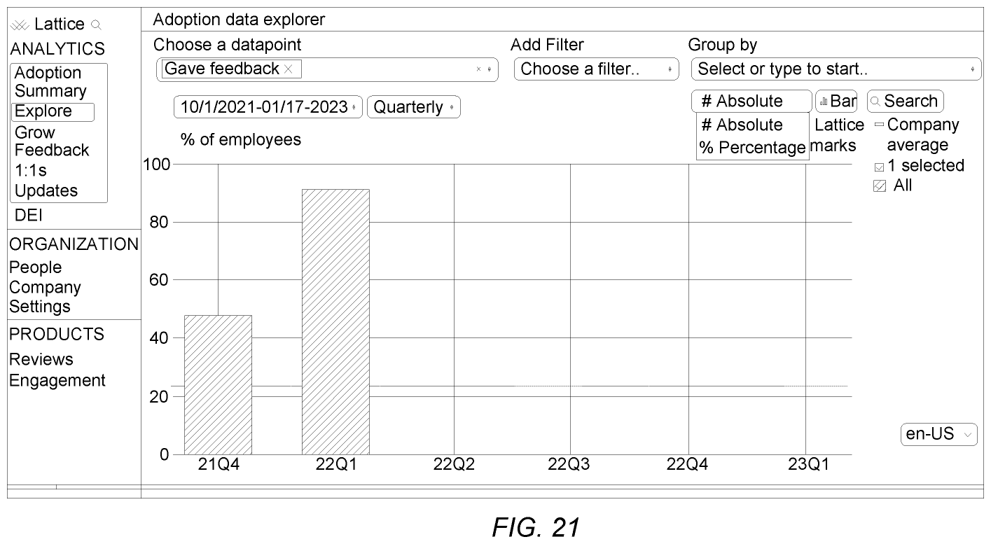

FIG. 21 is a block diagram illustrating further aspects of the example Data Explorer user interface. In example embodiments, one or more data items may be selected as viewable by percentage or absolute values. The Data Explorer user interface in FIG. 21 provides options for viewing data in percentage or absolute terms, offering flexibility in how insights are presented and interpreted. This feature allows users to choose the most meaningful representation for their analysis.

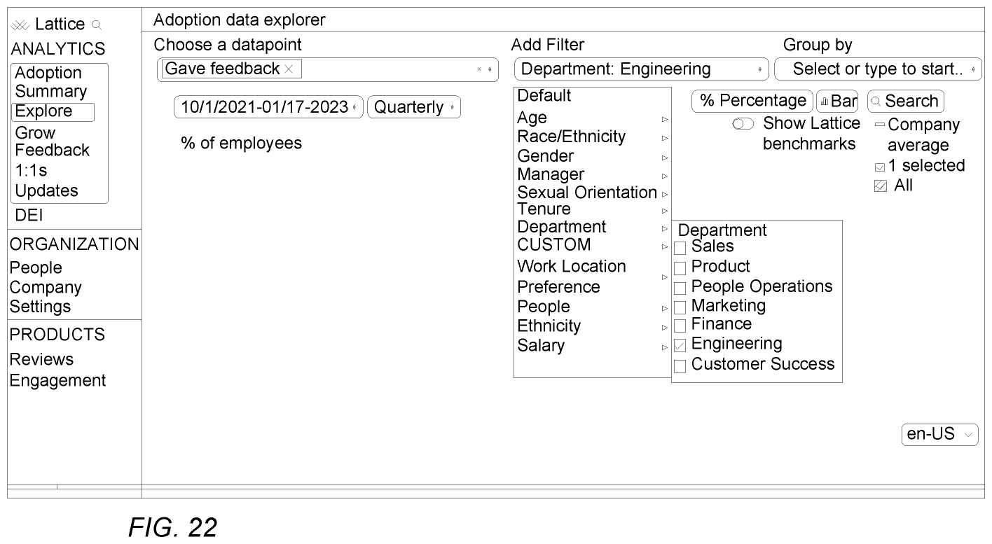

FIG. 22 is a block diagram illustrating further aspects of the example Data Explorer user interface. In example embodiments, filters of multiple layers may be applied to the data set, including filters by any combination of any of the data items described herein, and are selectable via a collapsible, multi-level menu. In FIG. 22, the Data Explorer user interface includes a multi-level filtering system that enables users to apply complex filters to the data set. This advanced functionality allows for the creation of highly targeted analytics.

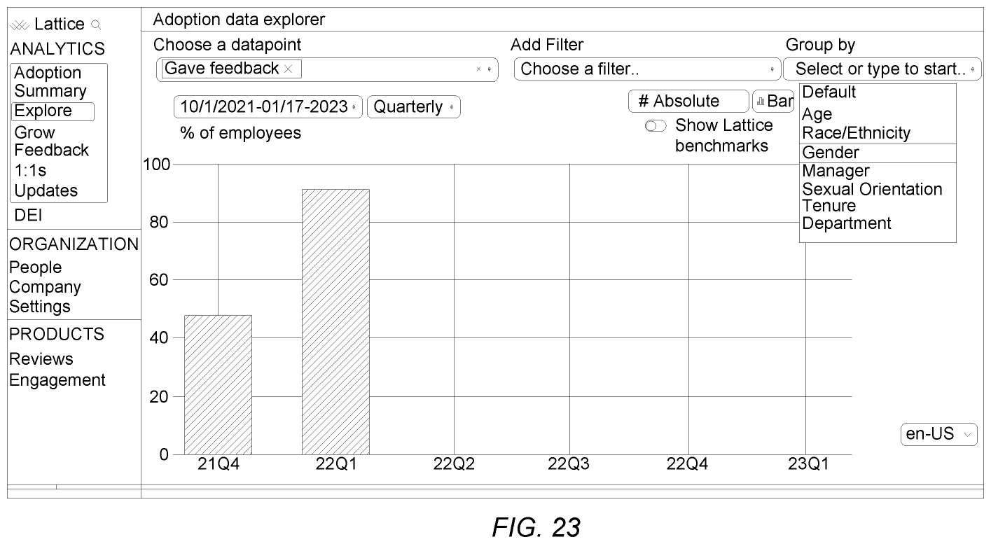

FIG. 23 is a block diagram illustrating further aspects of the example Data Explorer user interface. The filtered or unfiltered data may then be cut by other data (e.g., HRIS data items may be cut by ATS data items and vice versa) via selectable user interface elements (e.g., in a separate “Group by” drop down menu). The Data Explorer user interface's “Group by” feature allows users to organize data by various attributes. This capability enables users to uncover relationships and trends within the data that may not be immediately apparent.

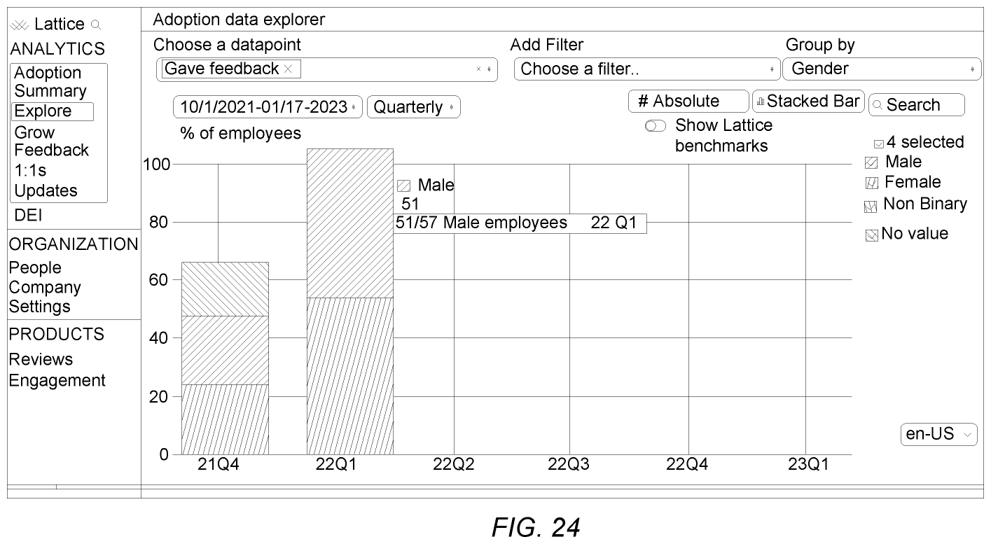

FIG. 24 is a block diagram illustrating further aspects of the example Data Explorer user interface. In example embodiments, a selectable user interface element allows for changing of the graph style to a stacked bar graph or other suitable graph for displaying the selected data according to the filters and groups that are applied. The Data Explorer user interface depicted in FIG. 24 introduces a stacked bar graph option, providing an alternative visualization method for comparing grouped data. This feature enhances the interpretability of complex data sets.

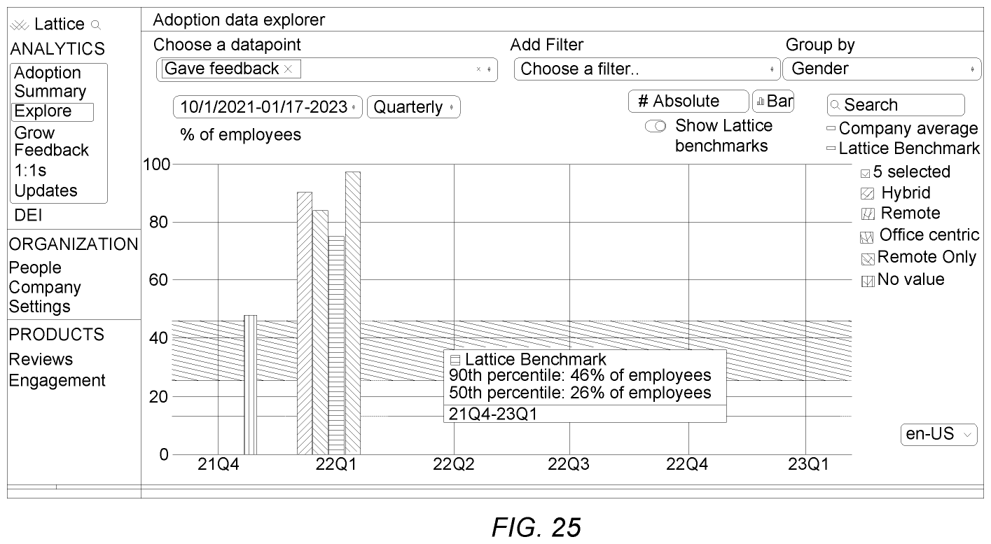

FIG. 25 is a block diagram illustrating further aspects of the example Data Explorer user interface. In example embodiments, a selectable user interface element (e.g., Show Lattice benchmarks) causes a user interface element to be overlaid over the graph that shows a percentile range associated with the graph. Here, the 90th percentile for the selected data point (e.g., “Gave feedback”) in the selected time frame (21 Q4-23 Q1) is 46% of the employees, and the 50th percentile is 26% of the employees, which his represented by the box that is horizontally overlaid across the time range. In FIG. 25, the Data Explorer user interface features a benchmark overlay, which provides contextual performance indicators against industry or internal standards. This addition aids users in evaluating their organization's performance relative to benchmarks.

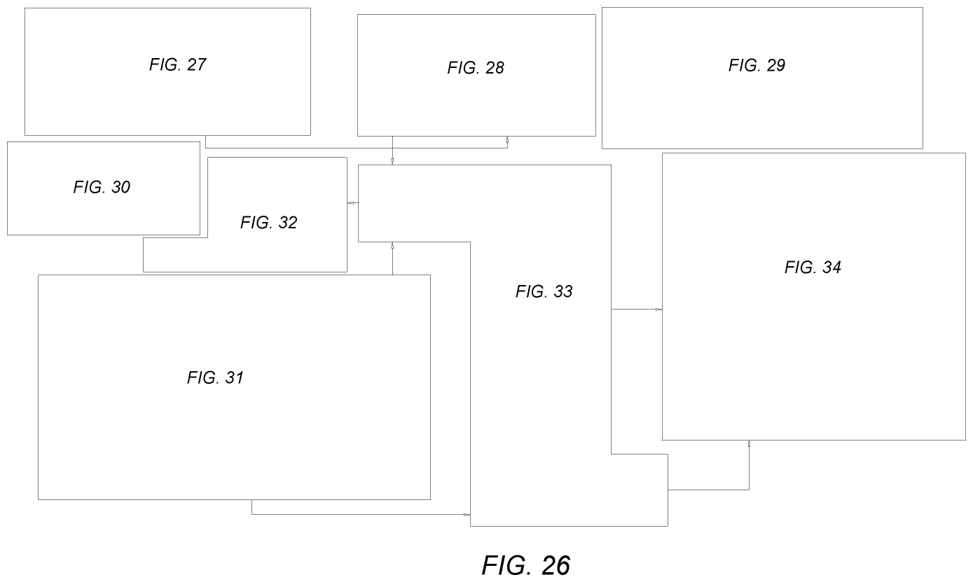

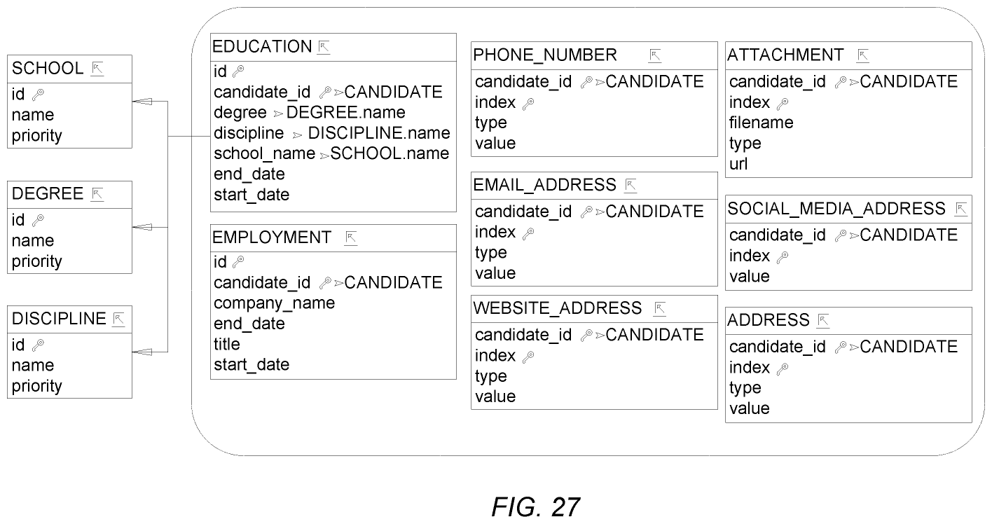

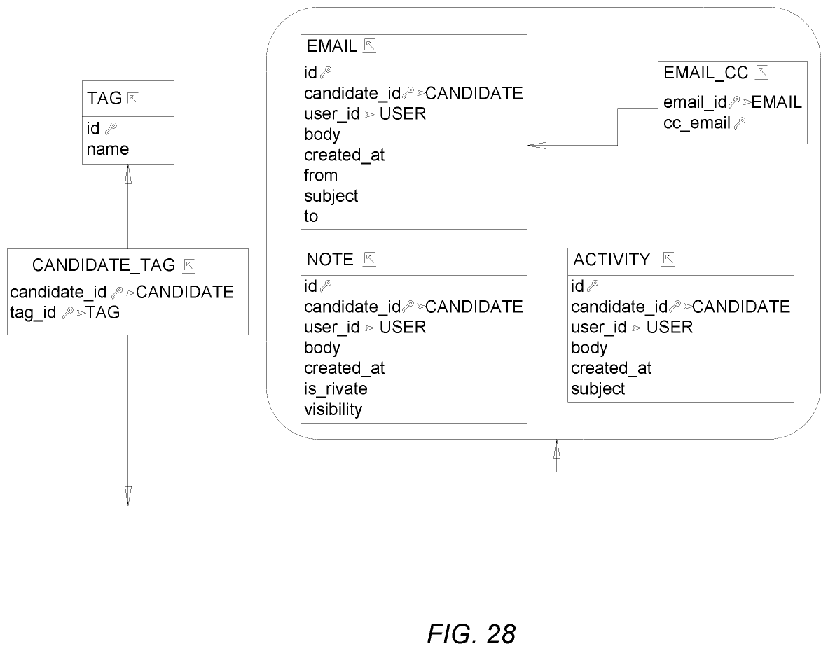

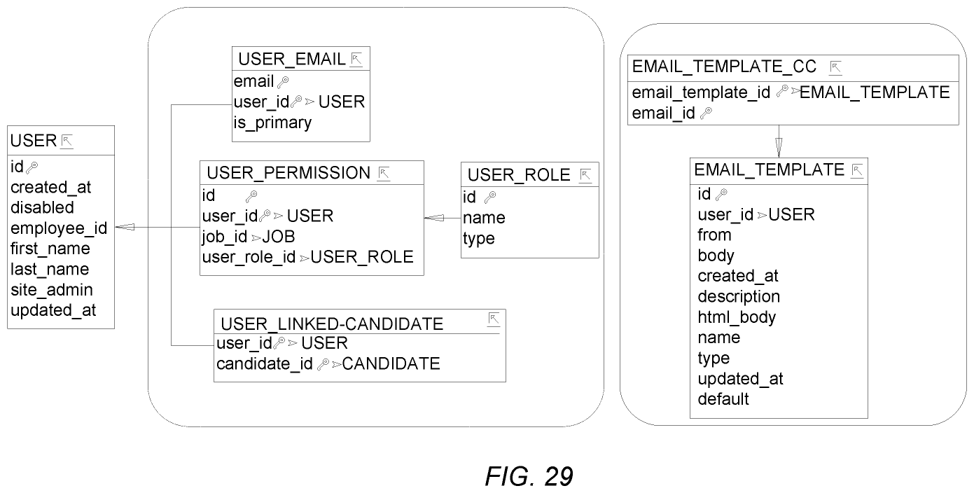

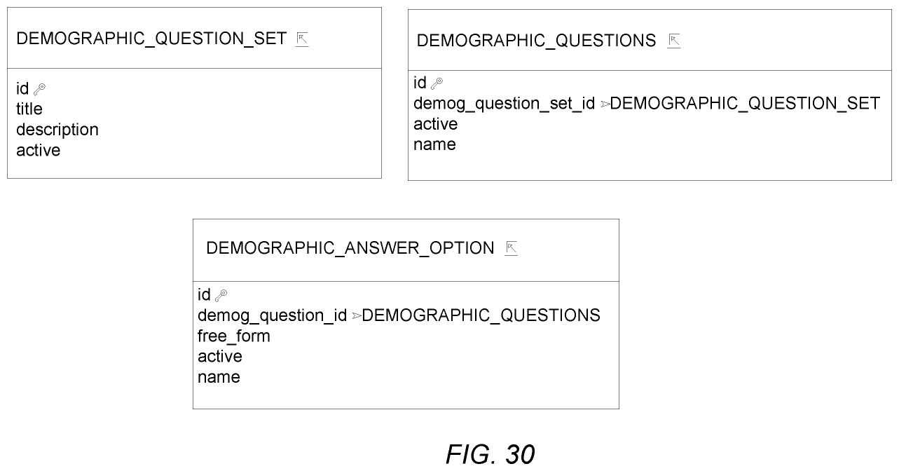

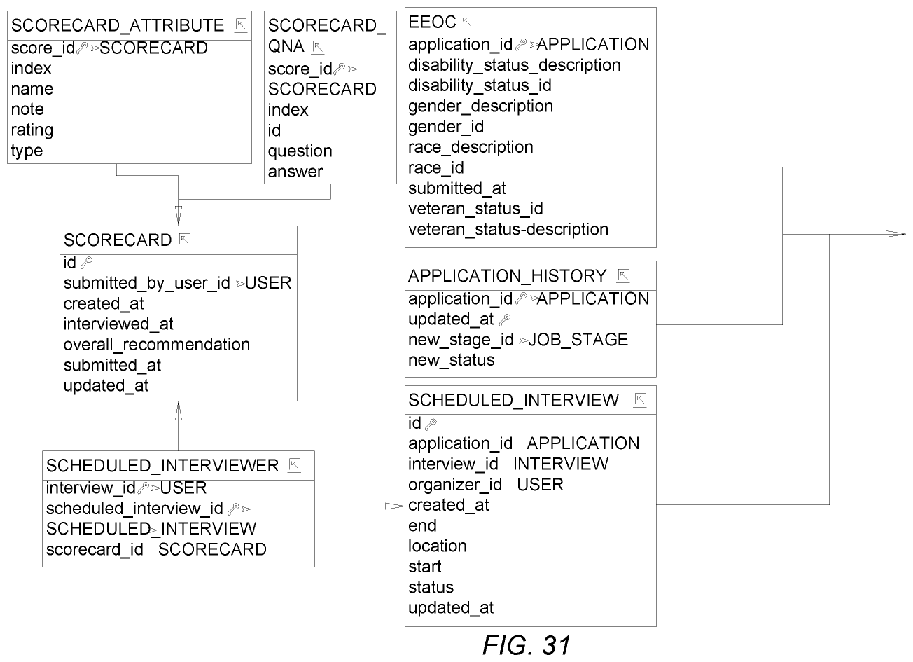

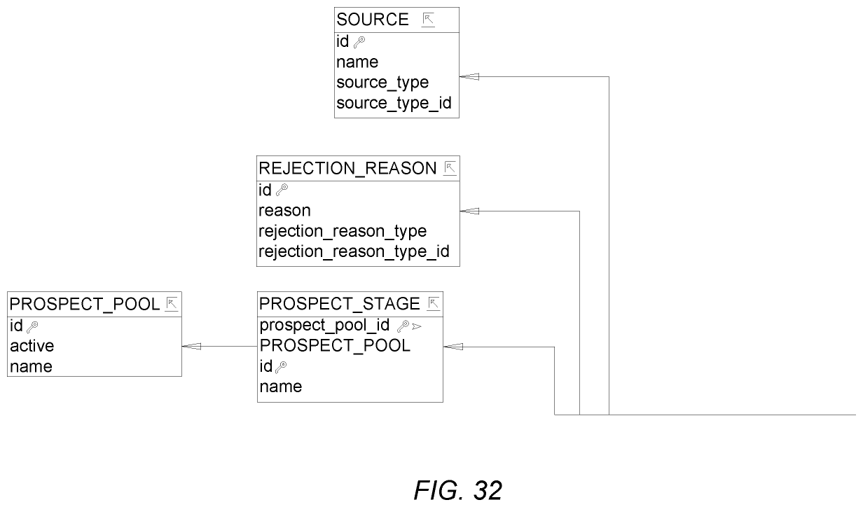

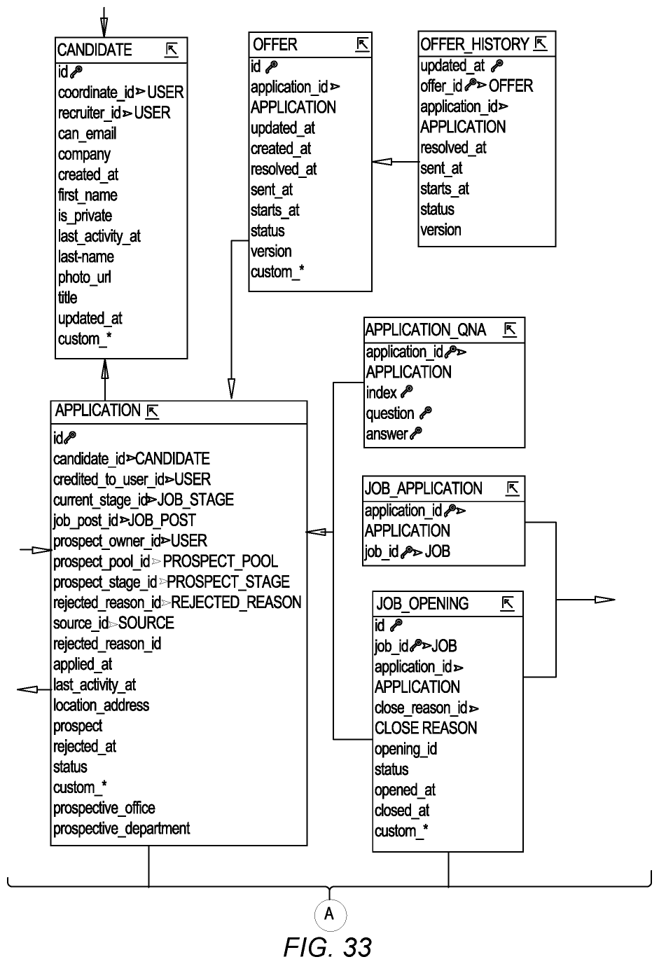

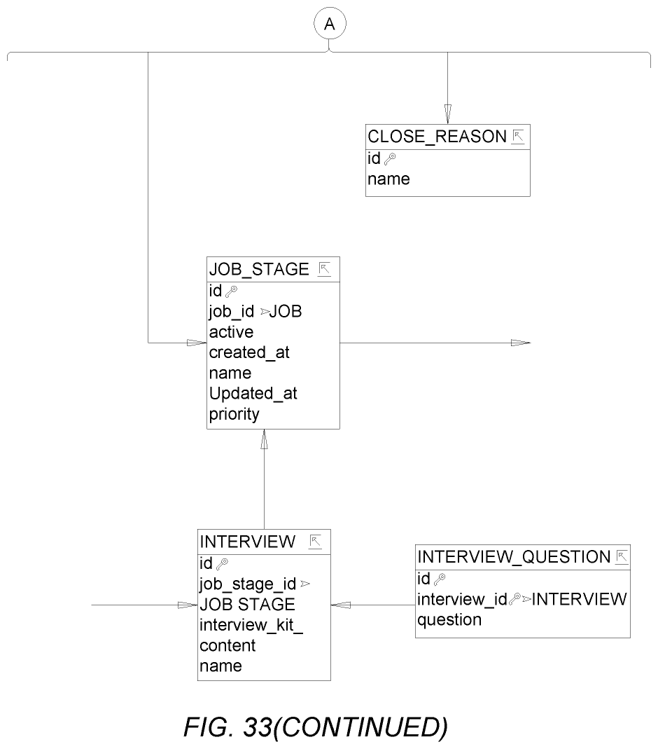

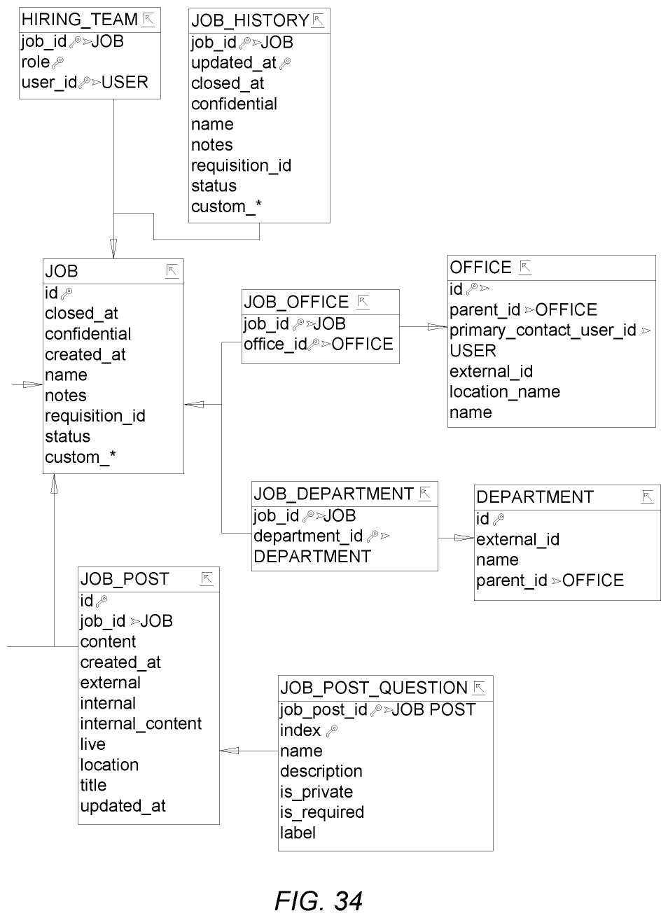

In example embodiments, one or more data items (or data points) are collected across the various subsystems, such as an ATS and HRIS, and may be placed into various data sets. Examples of data sets and subsets are depicted in FIGS. 26-34. One or more of these data points may be incorporated into one or more of the user interfaces described herein for selecting, filtering, and/or cutting or grouping, as described herein.

The series of diagrams from FIGS. 26-34 provide a detailed representation of example data models and relationships within the Unified Analytics API's ecosystem. These figures collectively illustrate an example underlying structure that supports the complex data interactions and analytical processes facilitated by the API.

FIG. 26 through FIG. 34 depict various entities and their interconnections, including candidate profiles, employment history, educational background, and other relevant HR data points. These entities are linked through relational mappings that enable the system to aggregate and analyze data across different dimensions, such as job functions, departments, and individual employee performance metrics.

The diagrams also show how the API can handle diverse data types, from structured data like numerical and categorical information to unstructured data such as text from resumes or feedback forms. The relationships between entities are designed to support advanced queries and analytics, allowing for the extraction of meaningful insights from the data.

Additionally, these figures demonstrate the API's capability to accommodate custom attributes and tags, providing organizations with the flexibility to tailor the system to their specific needs. The data models are designed to be extensible, ensuring that the system can evolve with the organization and adapt to future data requirements.

### Example Mobile Device

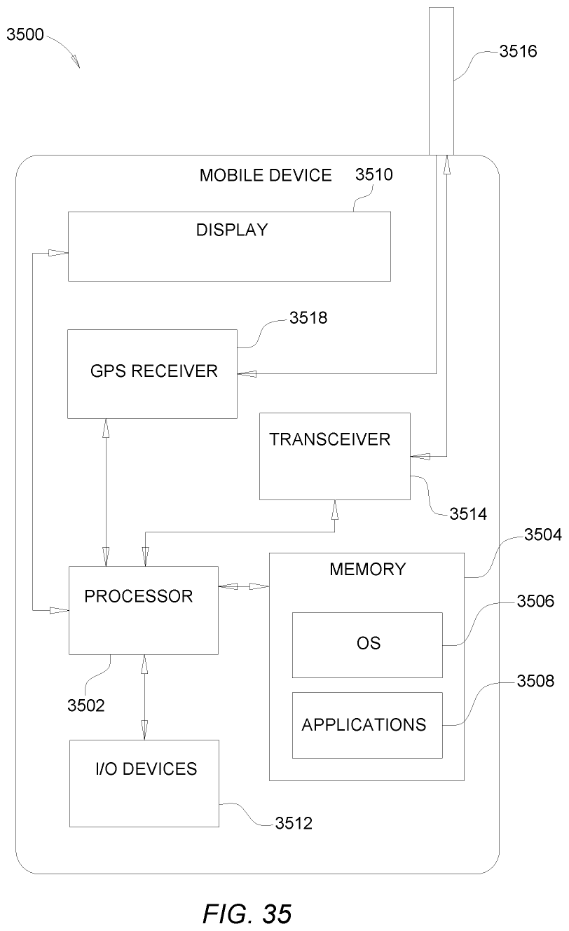

FIG. 35 is a block diagram illustrating a mobile device 3500, according to an example embodiment.

The mobile device 3500 can include a processor 3502. The processor 3502 can be any of a variety of different types of commercially available processors suitable for mobile devices 3500 (for example, an XScale architecture microprocessor, a Microprocessor without Interlocked Pipeline Stages (MIPS) architecture processor, or another type of processor). A memory 3504, such as a random access memory (RAM), a Flash memory, or other type of memory, is typically accessible to the processor 3502. The memory 3504 can be adapted to store an operating system (OS) 3506, as well as application programs 3508, such as a mobile location-enabled application that can provide location-based services (LBSs) to a user. The processor 3502 can be coupled, either directly or via appropriate intermediary hardware, to a display 3510 and to one or more input/output (I/O) devices 3512, such as a keypad, a touch panel sensor, a microphone, and the like. Similarly, in some embodiments, the processor 3502 can be coupled to a transceiver 3514 that interfaces with an antenna 3516. The transceiver 3514 can be configured to both transmit and receive cellular network signals, wireless data signals, or other types of signals via the antenna 3516, depending on the nature of the mobile device 3500. Further, in some configurations, a GPS receiver 3518 can also make use of the antenna 3516 to receive GPS signals.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

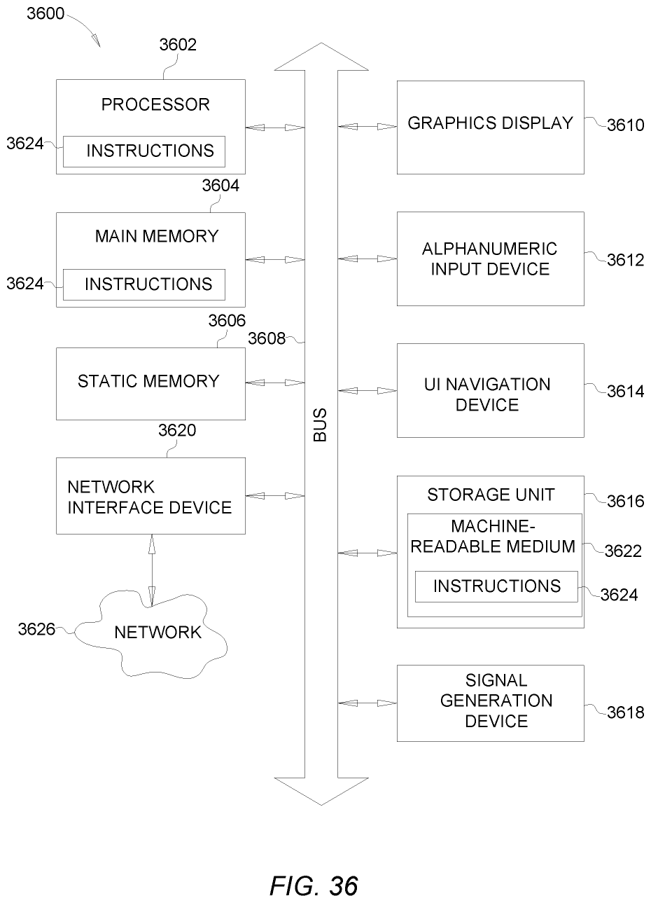

FIG. 36 is a block diagram of an example computer system 3600 on which methodologies and operations described herein may be executed, in accordance with an example embodiment.

In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 3600 includes a processor 3602 (e.g., a central processing unit (CPU), a graphics processing unit (GPU) or both), a main memory 3604 and a static memory 3606, which communicate with each other via a bus 3608. The computer system 3600 may further include a graphics display unit 3610 (e.g., a liquid crystal display (LCD) or a cathode ray tube (CRT)). The computer system 3600 also includes an alphanumeric input device 3612 (e.g., a keyboard or a touch-sensitive display screen), a user interface (UI) navigation device 3614 (e.g., a mouse), a storage unit 3616, a signal generation device 3618 (e.g., a speaker) and a network interface device 3620.

### Machine-Readable Medium

The storage unit 3616 includes a machine-readable medium 3622 on which is stored one or more sets of instructions and data structures (e.g., software) 3624 embodying or utilized by any one or more of the methodologies or functions described herein. The instructions 3624 may also reside, completely or at least partially, within the main memory 3604 and/or within the processor 3602 during execution thereof by the computer system 3600, the main memory 3604 and the processor 3602 also constituting machine-readable media.

While the machine-readable medium 3622 is shown in an example embodiment to be a single medium, the term “machine-readable medium” may include a single medium or multiple media (e.g., a centralized or distributed database, and/or associated caches and servers) that store the one or more instructions 3624 or data structures. The term “machine-readable medium” shall also be taken to include any tangible medium that is capable of storing, encoding or carrying instructions (e.g., instructions 3624) for execution by the machine and that cause the machine to perform any one or more of the methodologies of the present disclosure, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 3624 may further be transmitted or received over a communications network 3626 using a transmission medium. The instructions 3624 may be transmitted using the network interface device 3620 and any one of a number of well-known transfer protocols (e.g., HTTP). Examples of communication networks include a local area network (“LAN”), a wide area network (“WAN”), the Internet, mobile telephone networks, Plain Old Telephone Service (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A system comprising:
one or more computer processors;
one or more computer memories;
a set of instructions stored in the one or more computer memories, the set of instructions configuring the one or more computer processors to perform operations, the operations comprising:
retrieving employment-related data from a plurality of disparate systems including a human resource information system (HRIS) and an applicant tracking system (ATS), wherein the data comprises applicant information and employee performance metrics;
transforming the retrieved data by standardizing and aggregating the data into a unified dataset based on a common semantic model that aligns definitions and formats across the disparate systems;
analyzing the unified dataset to identify trends, patterns, or correlations within the data using one or more predefined or machine learning algorithms; and
updating the unified dataset or corresponding analyses in real-time through an application programming interface (API).

2. The system of claim 1, wherein the retrieving comprises accessing data items from the HRIS and the ATS that includes information pertaining to employee goals, compensation, engagement, or applicant data gathered during the hiring process.

3. The system of claim 1, wherein the transforming comprises normalizing the data items to a common format or resolving semantic differences between data representations in the HRIS and the ATS.

4. The system of claim 1, wherein the analyzing comprises utilizing a set of predefined analytical tools that are accessible based on roles assigned to users.

5. The system of claim 1, wherein the analyzing comprises applying time series analysis techniques to the unified dataset.

6. The system of claim 1, wherein the updating comprises using a caching layer to enhance performance or responsiveness of the system.

7. The system of claim 1, wherein the API is configured to wrap APIs of individual subsystems contributing standardized point-in-time data APIs that expose subsystem data.

8. A method comprising:
retrieving employment-related data from a plurality of disparate systems including a human resource information system (HRIS) and an applicant tracking system (ATS), wherein the data comprises applicant information and employee performance metrics;
transforming the retrieved data by standardizing and aggregating the data into a unified dataset based on a common semantic model that aligns definitions and formats across the disparate systems;
analyzing the unified dataset to identify trends, patterns, or correlations within the data using one or more analytical or machine learning algorithms; and
updating the unified dataset or corresponding analyses in real-time through an application programming interface (API).

9. The method of claim 8, wherein the retrieving comprises accessing data items from the HRIS and the ATS that includes information pertaining to employee goals, compensation, engagement, or applicant data gathered during the hiring process.

10. The method of claim 8, wherein the transforming comprises normalizing the data items to a common format or resolving semantic differences between data representations in the HRIS and the ATS.

11. The method of claim 8, wherein the analyzing comprises utilizing a set of predefined analytical tools that are accessible based on roles assigned to users.

12. The method of claim 8, wherein the analyzing comprises applying time series analysis techniques to the unified dataset.

13. The method of claim 8, wherein the updating comprises using a caching layer to enhance performance or responsiveness of the system.

14. The method of claim 8, wherein the API is configured to wrap APIs of individual subsystems contributing standardized point-in-time data APIs that expose subsystem data.

15. A non-transitory computer-readable storage medium storing a set of instructions that, when executed by one or more computer processors, causes the one or more computer processors to perform operations, the operations comprising:
retrieving employment-related data from a plurality of disparate systems including a human resource information system (HRIS) and an applicant tracking system (ATS), wherein the data comprises applicant information and employee performance metrics;
transforming the retrieved data by standardizing and aggregating the data into a unified dataset based on a common semantic model that aligns definitions and formats across the disparate systems;
analyzing the unified dataset to identify trends, patterns, or correlations within the data using one or more analytical or machine learning algorithms; and
updating the unified dataset or corresponding analyses in real-time through an application programming interface (API).

16. The non-transitory computer-readable storage medium of claim 15, wherein the retrieving comprises accessing data items from the HRIS and the ATS that includes information pertaining to employee goals, compensation, engagement, or applicant data gathered during the hiring process.

17. The non-transitory computer-readable storage medium of claim 15, wherein the transforming comprises normalizing the data items to a common format or resolving semantic differences between data representations in the HRIS and the ATS.

18. The non-transitory computer-readable storage medium of claim 15, wherein the analyzing comprises utilizing a set of predefined analytical tools that are accessible based on roles assigned to users.

19. The non-transitory computer-readable storage medium of claim 15, wherein the analyzing comprises applying time series analysis techniques to the unified dataset.

20. The non-transitory computer-readable storage medium of claim 15, wherein the updating comprises using a caching layer to enhance performance or responsiveness of the system.
